(19) United States
(12) Patent Application Publication
(10) Pub. No.: US 2026/0204830 A1
(43) Pub. Date: Jul. 16, 2026

(54) TAMPER-RESISTANT SELF-CONTAINED DEVICES

(71) Applicant: Pass & Seymour, Inc., Syracuse, NY (US)

(72) Inventors: Miguel Castañeda, Syracuse, NY (US); Harold Watkins, Chittenango, NY (US)

(73) Assignee: Pass & Seymour, Inc., Syracuse, NY (US)

(21) Appl. No.: 19/419,233

(22) Filed: Dec. 15, 2025

Related U.S. Application Data
(60) Provisional application No. 63/733,756, filed on Dec. 13, 2024.

(51) Int. Cl. H01R 13/447; H01R 13/512; H01R 25/00; H01R 105/00

(52) U.S. Cl. CPC H01R 13/447; H01R 13/512; H01R 25/006; H01R 2105/00

(57) ABSTRACT

The present invention relates generally to electrical wiring devices/assemblies, and particularly to tamper-resistant self-contained electrical wiring devices/assemblies having tamper-resistant components and configured to be used in mobile homes and recreational vehicles.

### CROSS-REFERENCE TO RELATED APPLICATIONS

The present application claims priority to U.S. Provisional Application No. 63/733,756, filed on Dec. 13, 2024, hereby incorporated by reference in its entirety.

### BACKGROUND OF THE INVENTION

### 1. Field of the Invention

The present invention relates generally to electrical wiring devices/assemblies, and particularly to tamper-resistant self-contained electrical wiring devices/assemblies configured to be used in mobile homes and recreational vehicles.

### 2. Description of the Related Art

Self-contained devices (SCD) are known and are used in manufactured homes and recreational vehicles and installed when the manufactured homes/recreational vehicles are built in a manufacturing plant. The National Electrical Code (NEC) defines an SCD as an electrical appliance or piece of equipment that has all necessary components, including power source, controls, and wiring, fully integrated within its housing, requiring no external connections or wiring for basic operation; essentially, it is a complete unit that functions independently. An electrical receptacle, for example, can be referred to as an example SCD—a device that can be used without a box in exposed or concealed installations. The U.S. Department of Housing and Urban Development (HUD) controls code requirements for manufactured home construction and is adopting the 2014 NEC rules requiring tamper-resistant receptacles for manufactured homes.

Description of the Related Art Section Disclaimer: To the extent that specific patents/publications/products are discussed above in this Background Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products (and/or specific portions thereof) are discussed above in this Background Section and/or throughout the application, the descriptions/disclosures of which are all hereby incorporated by reference into this document in their respective entirety(ies) (or at least the specific references sections are incorporated by reference into this document in their respective entirety(ies), as may be applicable).

### BRIEF SUMMARY OF THE INVENTION

The inventors recognize there are several drawbacks associated with conventional self-contained wiring devices used in mobile homes or recreational vehicles. For example, such conventional devices/assemblies are not tamper-resistant, and could be improved with respect to complying with the above referenced NEC/HUD requirements (as should be understood by a person of ordinary skill in the art in conjunction with a review of this disclosure and a review of the tamper resistant patents identified herein).

It is therefore a principal object and advantage of the present invention to provide embodiments of electrical wiring device assemblies that eliminate one or more of the problems/issues discussed above. In particular, the present disclosure is directed to inventive tamper-resistant self-contained wiring devices and assemblies that provide added protection with respect to the tamper-resistant components while complying (and improving upon performance of conventional devices/assemblies) with the above referenced NEC/HUD requirements.

These and other aspects of the invention will be apparent from and elucidated with reference to the embodiment(s) described hereinafter.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following description taken in conjunction with the accompanying drawings in which:

FIG. 1A is a front view schematic representation of a 15 A version of a fully assembled tamper-resistant self-contained device, according to an embodiment;

FIG. 1B is a front perspective view schematic representation of the tamper-resistant self-contained device, according to an embodiment;

FIG. 1C is a bottom view schematic representation of the tamper-resistant self-contained device, according to an embodiment;

FIG. 1D is a bottom view schematic representation of the tamper-resistant self-contained device, according to an embodiment;

FIG. 1E is a rear view schematic representation of the tamper-resistant self-contained device, according to an embodiment;

FIG. 1F is a rear perspective view schematic representation of the tamper-resistant self-contained device, according to an embodiment;

FIG. 1G is a front perspective view of the tamper-resistant self-contained device with certain components removed to show certain interior components, according to an embodiment;

FIG. 1H is a front perspective view of the tamper-resistant self-contained device with certain components removed to show certain interior components, according to an embodiment;

FIG. 1I is a side perspective view of the tamper-resistant self-contained device with certain components removed to show certain interior components, according to an embodiment;

FIG. 1J is an exploded view schematic representation of the tamper-resistant self-contained device, according to an embodiment;

FIG. 1K is an exploded view of a shutter assembly portion of the tamper-resistant self-contained device, according to an embodiment;

FIG. 2A is a top view schematic representation of a 20 A version of a fully assembled tamper-resistant self-contained device, according to an embodiment;

FIG. 2B is a top perspective view schematic representation of the tamper-resistant self-contained device, according to an embodiment;

FIG. 2C is a rear view schematic representation of the tamper-resistant self-contained device, according to an embodiment;

FIG. 2D is a front perspective view of the tamper-resistant self-contained device with certain components removed to show certain interior components, according to an embodiment;

FIG. 2E is a front perspective view of the tamper-resistant self-contained device with certain components removed to show certain interior components, according to an embodiment;

FIG. 2F is an exploded view schematic representation of the tamper-resistant self-contained device, according to an embodiment;

FIG. 2G is an exploded view of a shutter assembly portion of the tamper-resistant self-contained device, according to an embodiment;

FIG. 3A is a front perspective view schematic representation of the tamper-resistant self-contained device, according to an alternative embodiment;

FIG. 3B is a front perspective view of the tamper-resistant self-contained device with certain components removed to show certain interior components, according to an alternative embodiment;

FIG. 3C is a rear view schematic representation of the tamper-resistant self-contained device, according to an alternative embodiment;

FIG. 4A is a front perspective view schematic representation of the tamper-resistant self-contained device, according to an alternative embodiment;

FIG. 4B is a front perspective view of the tamper-resistant self-contained device with certain components removed to show certain interior components, according to an alternative embodiment;

FIG. 4C is a rear view schematic representation of the tamper-resistant self-contained device, according to an alternative embodiment;

FIG. 5 is an exploded view of a shutter assembly portion of the tamper-resistant self-contained device, according to an alternative embodiment;

FIG. 6 is an exploded view of a shutter assembly portion of the tamper-resistant self-contained device, according to an alternative embodiment;

FIG. 7A is a sectioned view of a housing having a shutter assembly, according to an embodiment;

FIG. 7B is a magnified view of the shutter assembly of FIG. 7A, according to an embodiment;

FIG. 7C is a sectioned view of a housing having a shutter assembly, according to an alternative embodiment;

FIG. 7D is a magnified view of the shutter assembly of FIG. 7C, according to an alternative embodiment.

FIG. 8A is a front view schematic representation of a cover (Deco, 15 A) of a tamper-resistant self-contained device, according to an embodiment;

FIG. 8B is another view schematic representation of the cover of a tamper-resistant self-contained device, according to an embodiment;

FIG. 8C is another view schematic representation of the cover of a tamper-resistant self-contained device, according to an embodiment;

FIG. 8D is another view schematic representation of the cover of a tamper-resistant self-contained device, according to an embodiment;

FIG. 8E is another view schematic representation of the cover of a tamper-resistant self-contained device, according to an embodiment;

FIG. 8F is another view schematic representation of the cover of a tamper-resistant self-contained device, according to an embodiment;

FIG. 8G is another view schematic representation of the cover of a tamper-resistant self-contained device, according to an embodiment;

FIG. 8H is another view schematic representation of the cover of a tamper-resistant self-contained device, according to an embodiment;

FIG. 8I a front view schematic representation of the cover of a tamper-resistant self-contained device, according to an alternative embodiment;

FIG. 8J is top view showing a cover (15 A) of a tamper-resistant self-contained device, according to another embodiment that is very similar to the embodiment of FIGS. 8A-I except for the single plug receptacle openings;

FIG. 9A is a front view schematic representation of a back body of a tamper-resistant self-contained device, according to an embodiment;

FIG. 9B is another view schematic representation of the back body of a tamper-resistant self-contained device, according to an embodiment;

FIG. 9C is another view schematic representation of the back body of a tamper-resistant self-contained device, according to an embodiment;

FIG. 9D is another view schematic representation of the back body of a tamper-resistant self-contained device, according to an embodiment;

FIG. 9E is another view schematic representation of a back body of a tamper-resistant self-contained device, according to an embodiment;

FIG. 9F is another view schematic representation of the back body of a tamper-resistant self-contained device, according to an embodiment;

FIG. 9G is another view schematic representation of the back body of a tamper-resistant self-contained device, according to an embodiment;

FIG. 9H is another view schematic representation of the back body of a tamper-resistant self-contained device, according to an embodiment;

FIG. 9I is another view schematic representation of the back body of a tamper-resistant self-contained device, according to an embodiment;

FIG. 9J is another view schematic representation of the back body of a tamper-resistant self-contained device, according to an embodiment;

FIG. 9K is another view schematic representation of the back body of a tamper-resistant self-contained device, according to an embodiment;

FIG. 9L is another view schematic representation of the back body of a tamper-resistant self-contained device, according to an embodiment;

FIG. 9M is another view schematic representation of the back body of a tamper-resistant self-contained device, according to an embodiment;

FIG. 9N is another view schematic representation of the back body of a tamper-resistant self-contained device, according to an embodiment;

FIG. 10A is a front view schematic representation of a cover (Duplex, 15 A) of a tamper-resistant self-contained device, according to an embodiment;

FIG. 10B is another view schematic representation of the cover of a tamper-resistant self-contained device, according to an embodiment;

FIG. 10C is another view schematic representation of the cover of a tamper-resistant self-contained device, according to an embodiment;

FIG. 10D is another view schematic representation of the cover of a tamper-resistant self-contained device, according to an embodiment;

FIG. 10E is another view schematic representation of the cover of a tamper-resistant self-contained device, according to an embodiment;

FIG. 10F is another view schematic representation of the cover of a tamper-resistant self-contained device, according to an embodiment;

FIG. 10G is another view schematic representation of the cover of a tamper-resistant self-contained device, according to an embodiment;

FIG. 10H is another view schematic representation of the cover of a tamper-resistant self-contained device, according to an embodiment;

FIG. 10I is another view schematic representation of the cover of a tamper-resistant self-contained device, according to an embodiment;

FIG. 11A is a first end view schematic representation of a spring of a taper resistant mechanism of a tamper-resistant self-contained device, according to an embodiment;

FIG. 11B is another view schematic representation of a spring of a taper resistant mechanism of a tamper-resistant self-contained device, according to an embodiment;

FIG. 11C is another view of a spring of a taper resistant mechanism of a tamper-resistant self-contained device, according to an embodiment;

FIG. 12A is a first view schematic representation of a swing bracket of a tamper-resistant self-contained device, according to an embodiment;

FIG. 12B is another view schematic representation of the swing bracket of a tamper-resistant self-contained device, according to an embodiment;

FIG. 12C is another view schematic representation of the swing bracket of a tamper-resistant self-contained device, according to an embodiment;

FIG. 12D is another view schematic representation of the swing bracket of a tamper-resistant self-contained device, according to an embodiment;

FIG. 13A is a perspective view schematic representation of a shutter of a tamper-resistant self-contained device, according to an embodiment;

FIG. 13B is another view schematic representation of the shutter of a tamper-resistant self-contained device, according to an embodiment;

FIG. 13C is another view schematic representation of the shutter of a tamper-resistant self-contained device, according to an embodiment;

FIG. 13D is another view schematic representation of the shutter of a tamper-resistant self-contained device, according to an embodiment;

FIG. 13E is another view schematic representation of the shutter of a tamper-resistant self-contained device, according to an embodiment;

FIG. 13F is another view schematic representation of the shutter of a tamper-resistant self-contained device, according to an embodiment;

FIG. 13G is another view schematic representation of the shutter of a tamper-resistant self-contained device, according to an embodiment;

FIG. 13H is another view schematic representation of the shutter of a tamper-resistant self-contained device, according to an embodiment;

FIG. 13I is another view schematic representation of the shutter of a tamper-resistant self-contained device, according to an embodiment;

FIG. 13J is another view schematic representation of the shutter of a tamper-resistant self-contained device, according to an embodiment;

FIG. 14A is a first view schematic representation of a ground contact of a tamper-resistant self-contained device, according to an embodiment;

FIG. 14B is another view schematic representation of the ground contact of a tamper-resistant self-contained device, according to an embodiment;

FIG. 14C is another view schematic representation of the ground contact of a tamper-resistant self-contained device, according to an embodiment;

FIG. 14D is another view schematic representation of the ground contact of a tamper-resistant self-contained device, according to an embodiment;

FIG. 15A is a first view schematic representation of a line terminal of a tamper-resistant self-contained device, according to an embodiment;

FIG. 15B is another view schematic representation of the line terminal of a tamper-resistant self-contained device, according to an embodiment;

FIG. 15C is another view schematic representation of the line terminal of a tamper-resistant self-contained device, according to an embodiment; and

FIG. 15D is another view schematic representation of the line terminal of a tamper-resistant self-contained device, according to an embodiment;

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

While embodiments of the present invention have been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements. If elements are shown in a particular Figure discussed below are not specifically identified with respect to that Figure, the elements should be sufficiently identified with respect to at least one other Figure.

The components described herein can be made of, for example, metal, rubber or plastic polymer, as should be understood by those of ordinary skill in the art in conjunction with this disclosure.

The embodiments described and illustrated herein can include tamper-resistant self-contained wiring devices, each of which can include a cover plate, tamper-resistant shutter, back body, and terminals in compliance with the NEC/HUD requirements (as should be understood by a person of ordinary skill in the art in conjunction with a review of this disclosure). In addition, aspects of the tamper resistant mechanisms of embodiments shown and described with respect to some of the accompanying drawings are further described in each of the following U.S. Pat. Nos. 5,006,075, 5,915,981, 7,312,394, 8,568,152, 9,847,611, 9,543,715, 9,893,456, and 11,502,445.

A 15 A version and a 20 A version of a tamper-resistant self-contained device are described and illustrated herein and designated generally throughout by reference numeral 100 or 100′, respectively. The associated shutters incorporated into these devices are designated by reference numeral 20 or 20′, respectively. In accordance with another embodiment, components of the 20 A version described herein can be used in the 15 A device, and components of the 15 A version can be used in the 20 A device (as should be understood by a person of ordinary skill in the art in conjunction with a review of this disclosure). Example shutter assemblies 20 or 20′ of embodiments of the present invention are positioned and are actuatable within respective electrical wiring devices and feature two main shutter positions: blocking position (resting state) and an open position (actuated state). The shutter assemblies can be structured, shaped, and configured to be assembled in and work with other electrical wiring devices which are structurally different from the 15 A and 20 A devices described herein, while maintaining the same or similar blocking position, open position, and movement in single/parallel plane between the two positions'structure and functionality as described herein. All of the FIGS. and descriptions therein or thereof are examples only, and nothing is specifically required (e.g., overly critical, must be, or need include one embodiment, component or another) unless so specifically and expressly claimed.

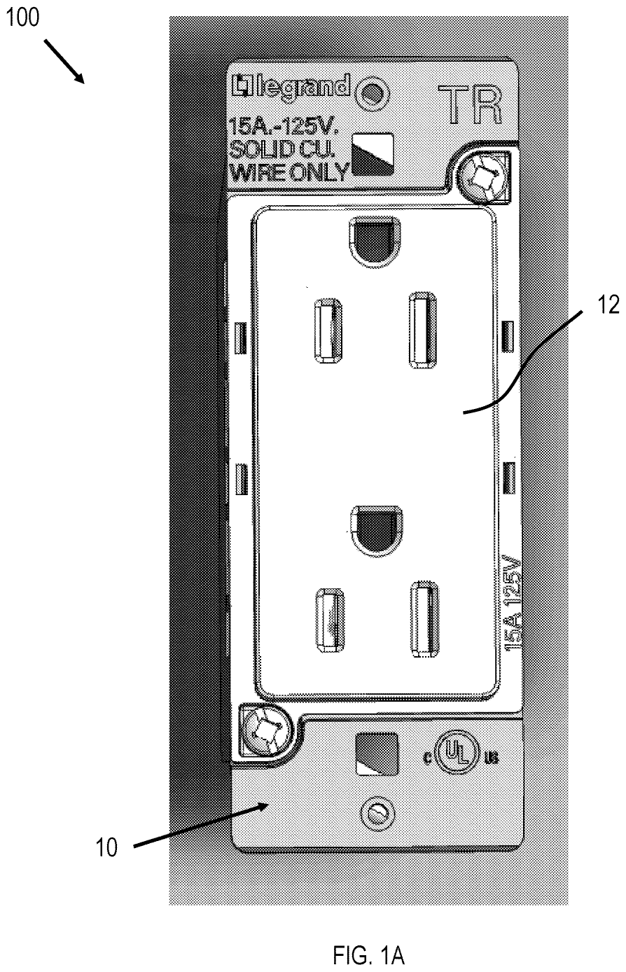

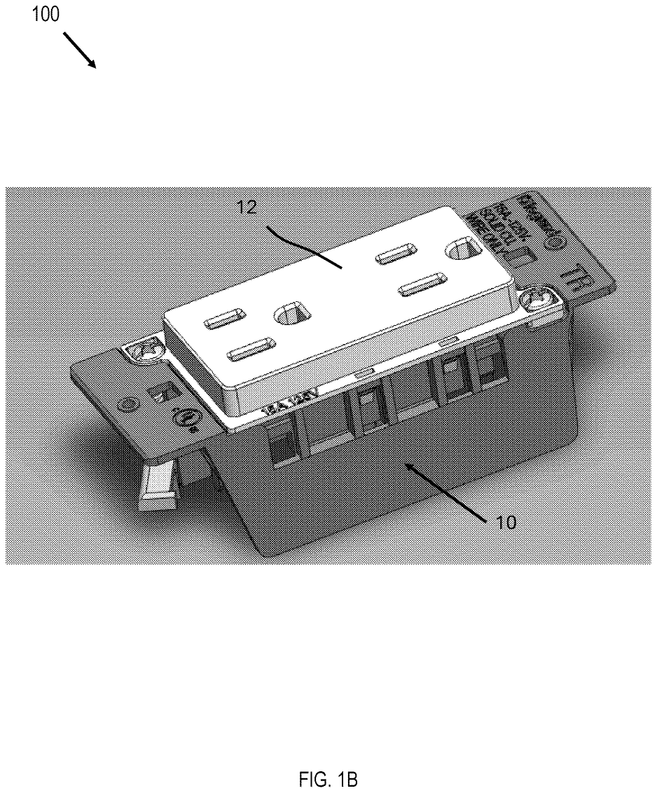

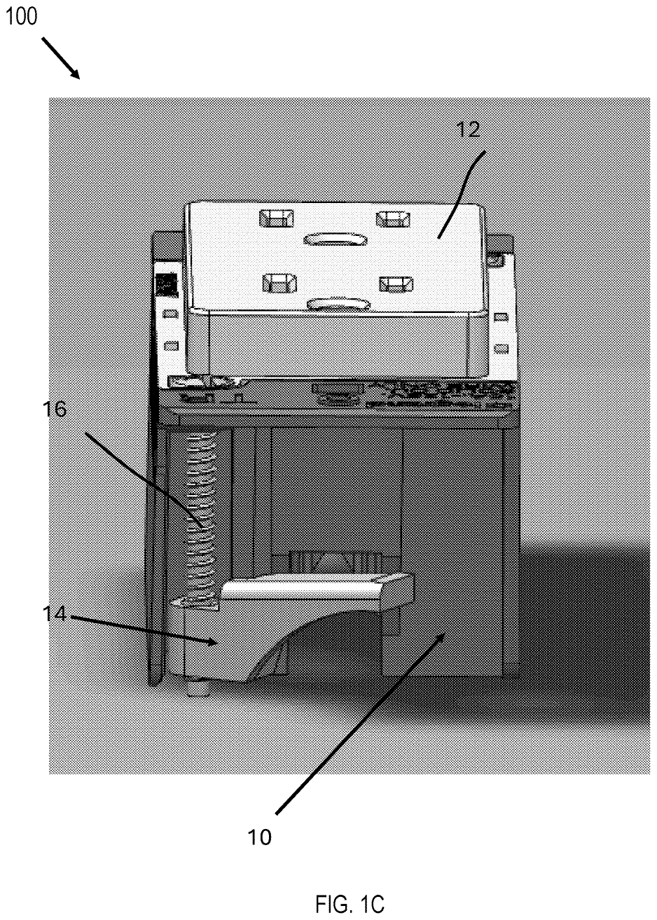

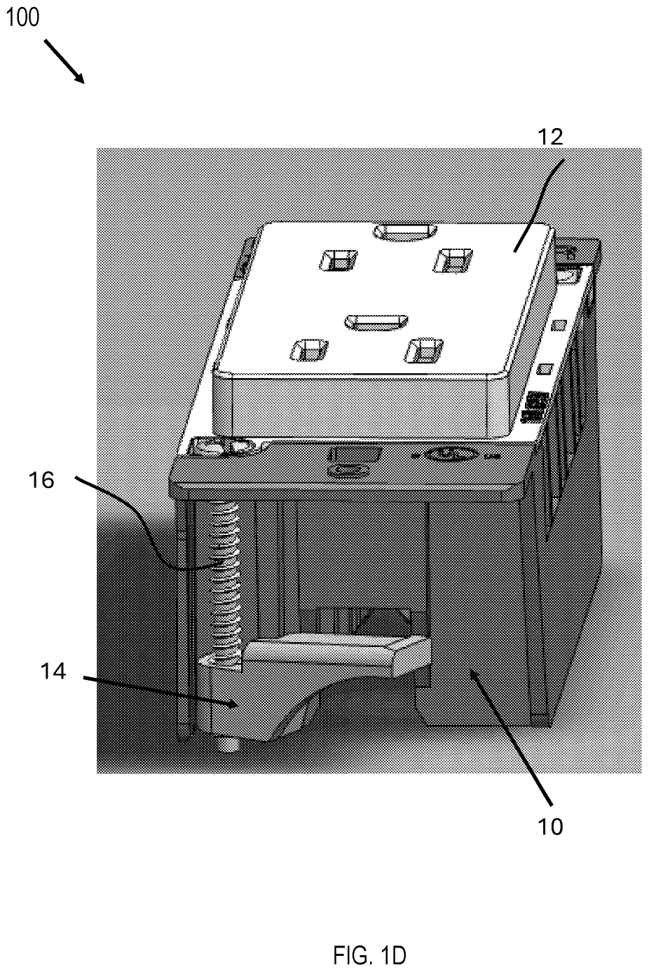

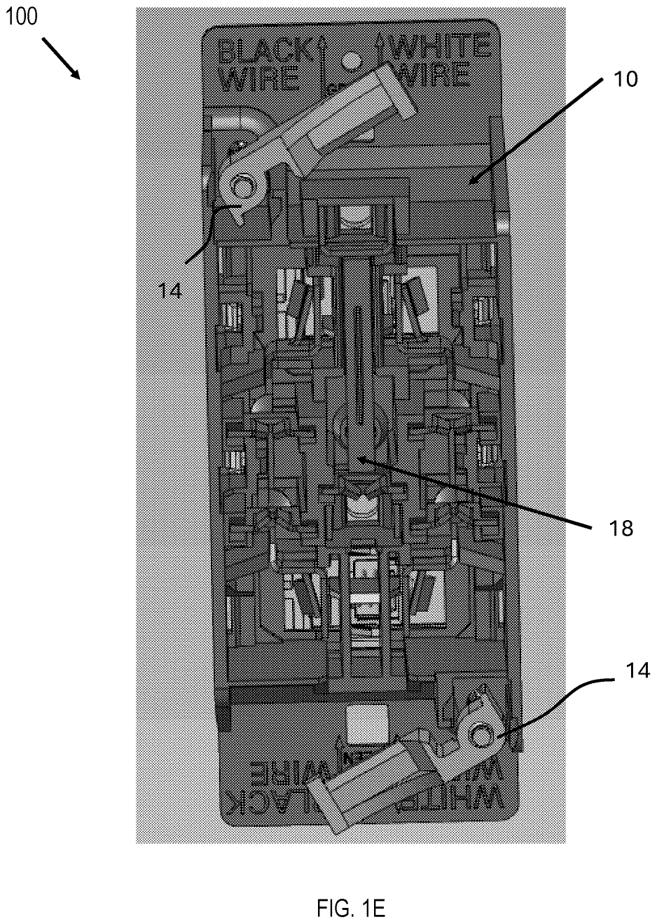

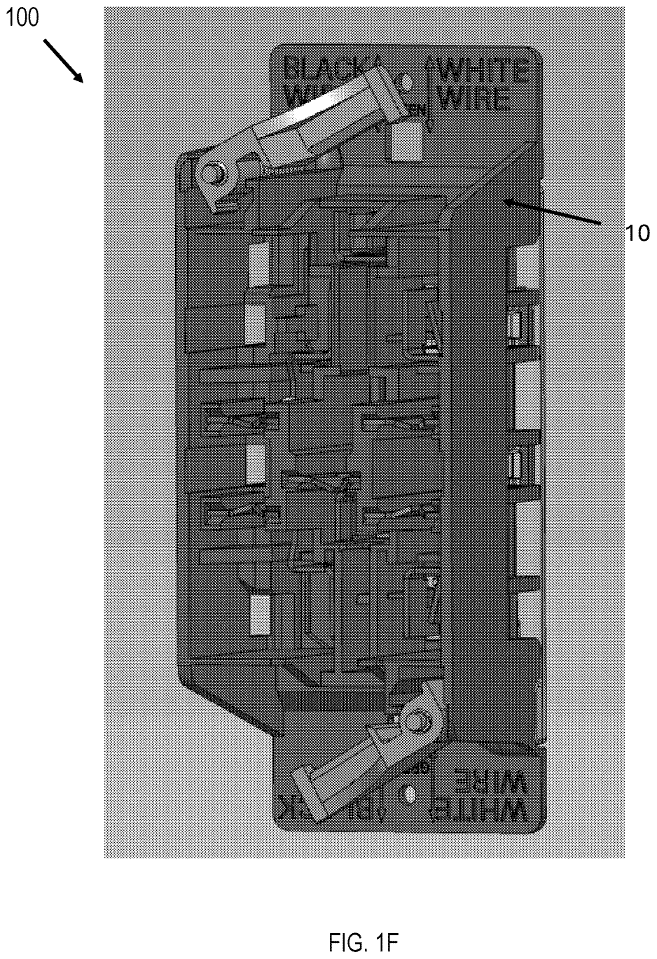

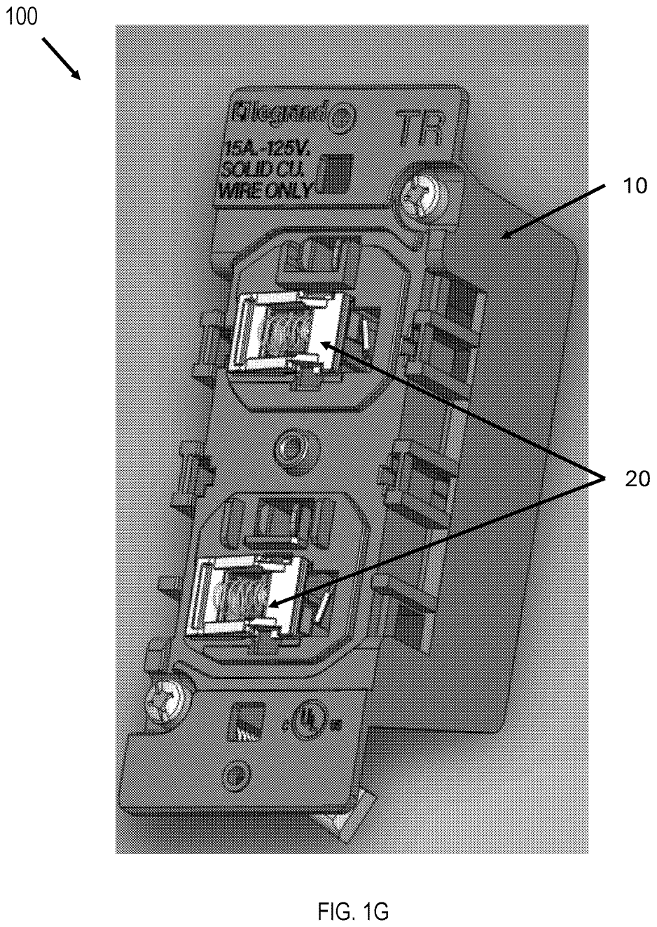

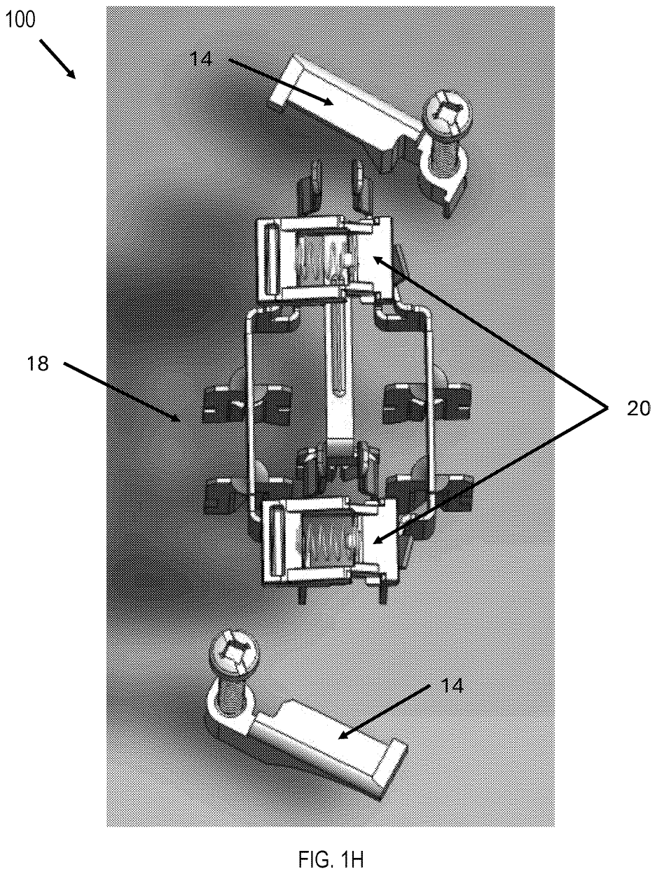

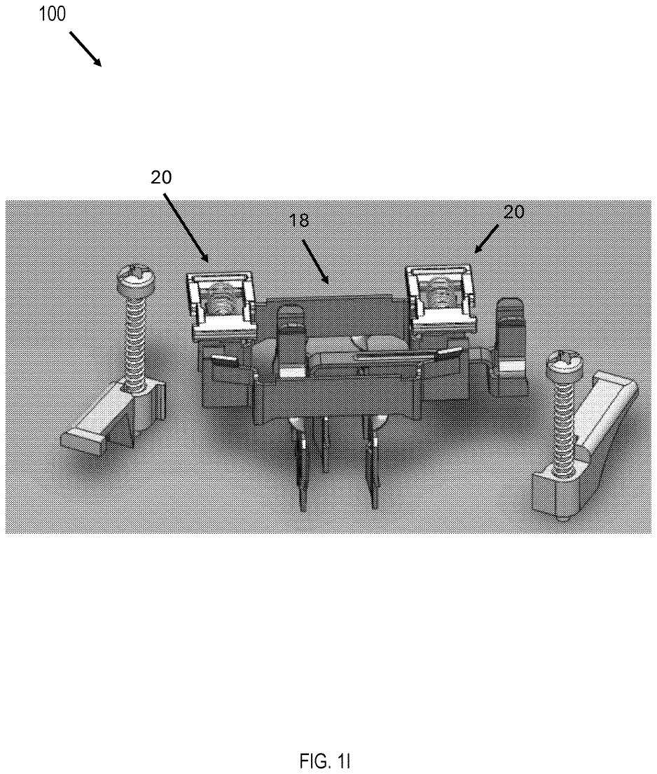

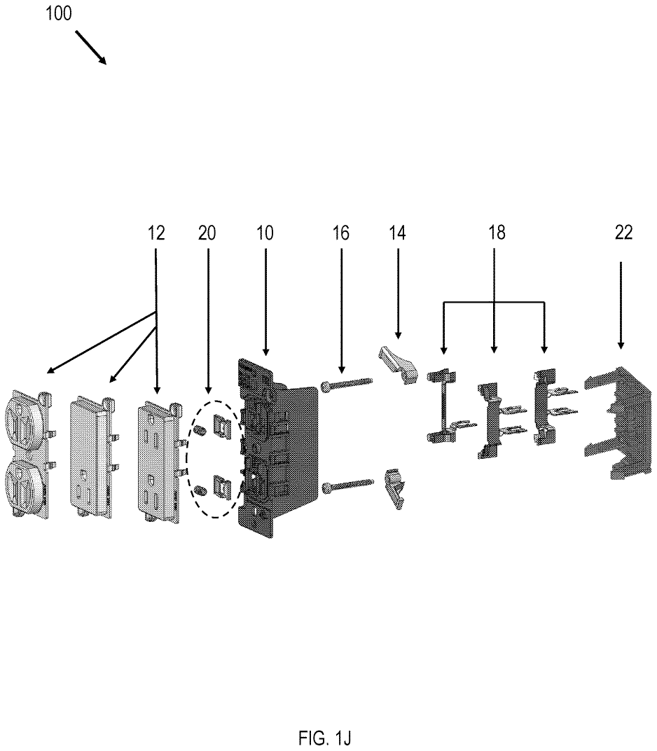

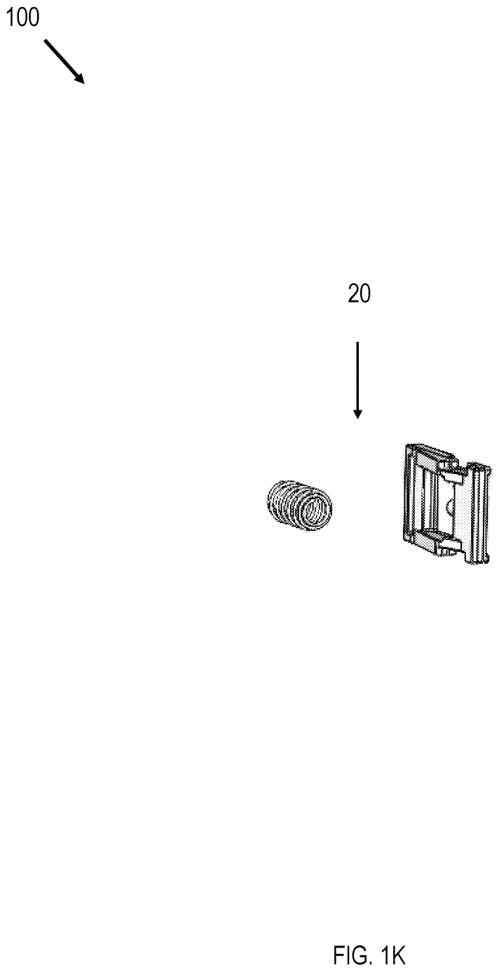

FIGS. 1A-1K show a 15 A version of a tamper-resistant self-contained device 100 in accordance with an embodiment of the present disclosure.

FIGS. 1A-1D show fully assembled tamper-resistant self-contained devices 100 structured and configured as described above. The tamper-resistant self-contained device 100 can include a back body 10 and a cover plate 12 that can be secured to the back body 10 by clamps 14 and/or screws 16. In some embodiments, the cover plate 12 is interchangeable with different cover plates, such as the ones described below.

FIGS. 1E and 1F show the rear/back of the fully assembled tamper-resistant self-contained device 100. As shown, terminals 18 are positioned within the device, including a ground terminal and a hot/neutral terminal. In this example, the terminals 18 are backed up with supporting ribs.

Referring now to FIG. 1G, a front perspective view of the tamper-resistant self-contained device 100 is shown with the cover plate 12 removed for illustrative purposes. As shown, tamper-resistant shutters 20 are positioned in contacting or in covering/protecting relation with the terminals 18.

Referring to FIGS. 1H and 1I, deconstructed views of the tamper-resistant self-contained device 100 with the cover plate and back body removed for illustrative purposes are shown.

Referring now to FIG. 1J, an exploded view of the tamper-resistant self-contained device 100 is shown. In some embodiments, a back lid 22 can be included that is capable of snapping or otherwise fitting onto the underside of the back body 10. In addition, FIG. 1J shows examples of covers 12 that can be part of the device 100 (as should be understood by a person or ordinary skill in the art in conjunction with a review of this disclosure). Referring to FIG. 1K, a deconstructed view of a tamper-resistant shutter 20 is shown (with spring and shutter portions).

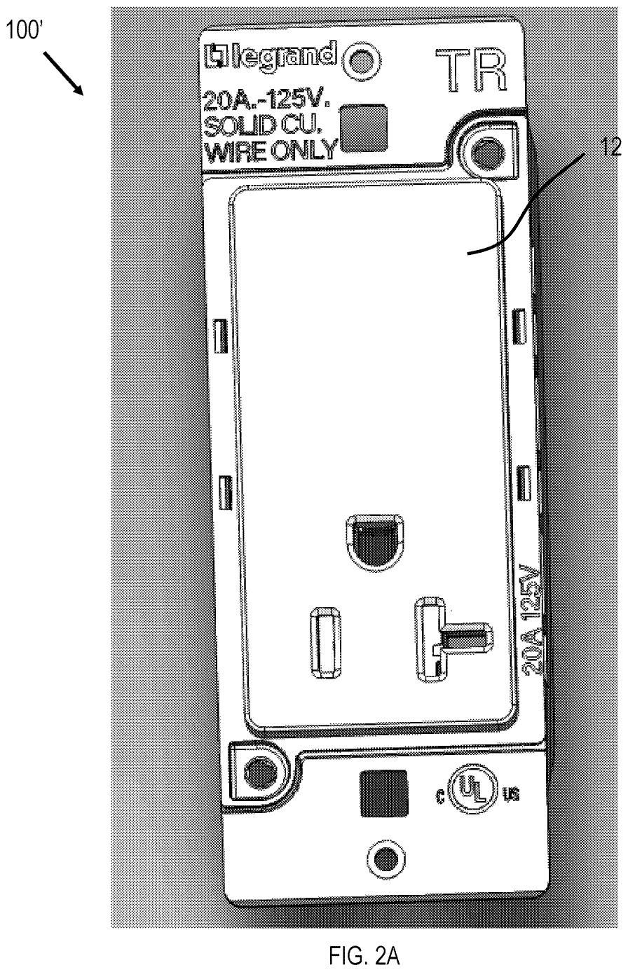

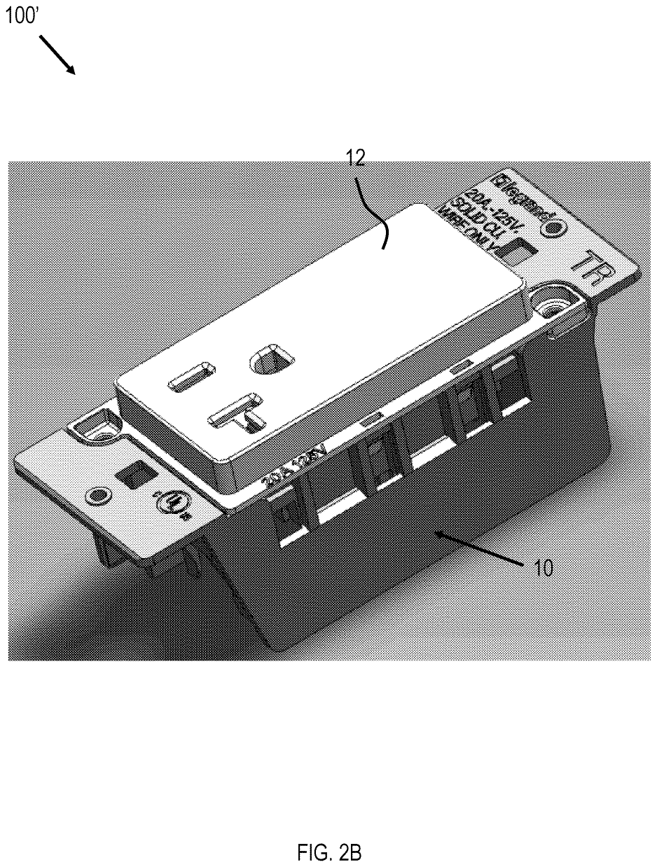

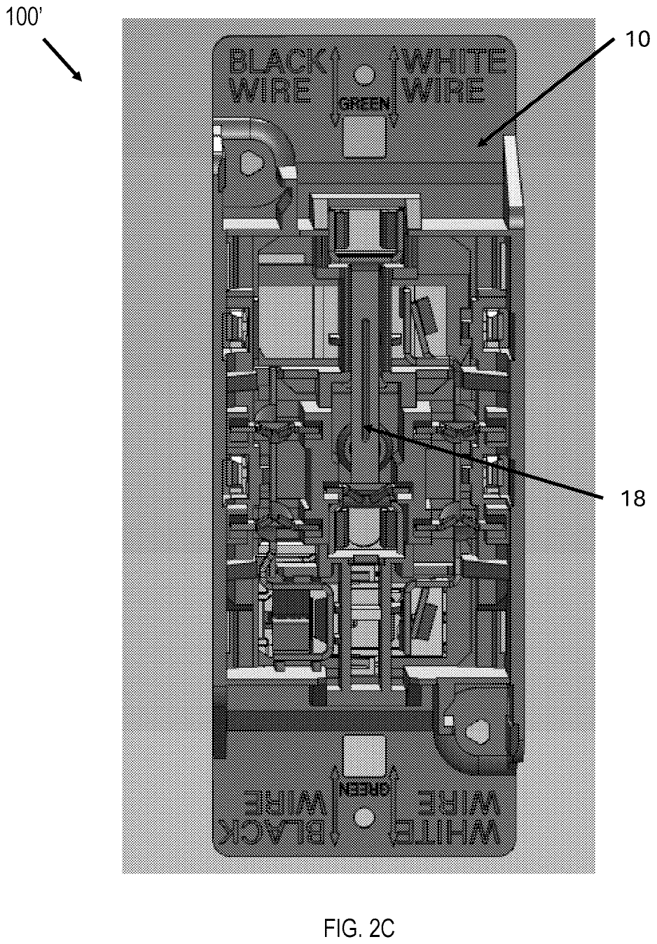

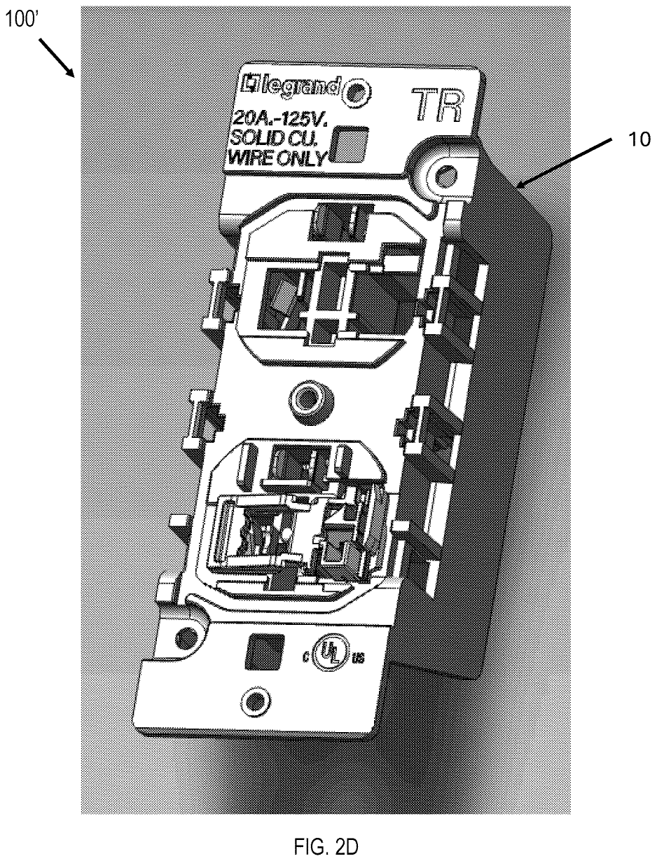

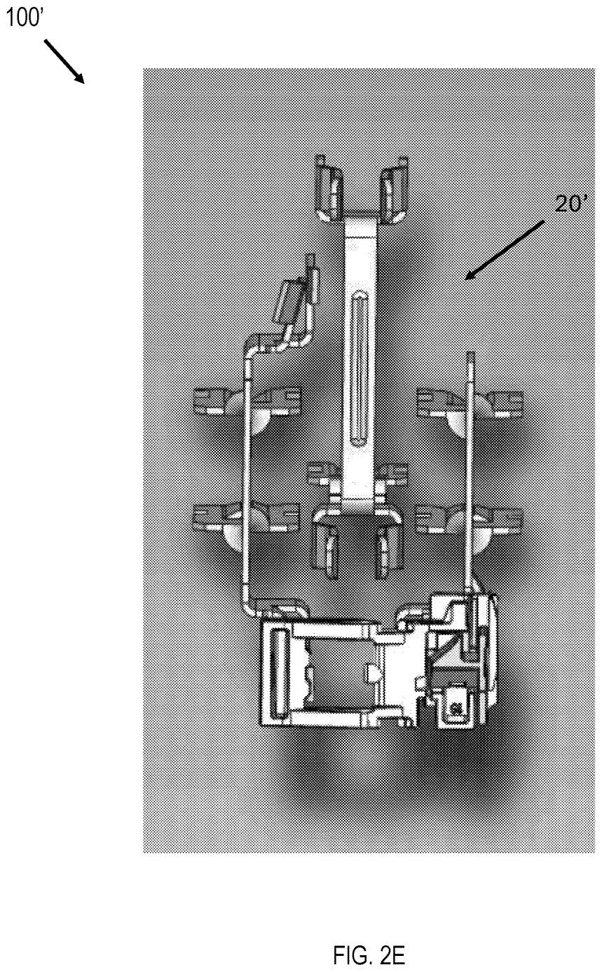

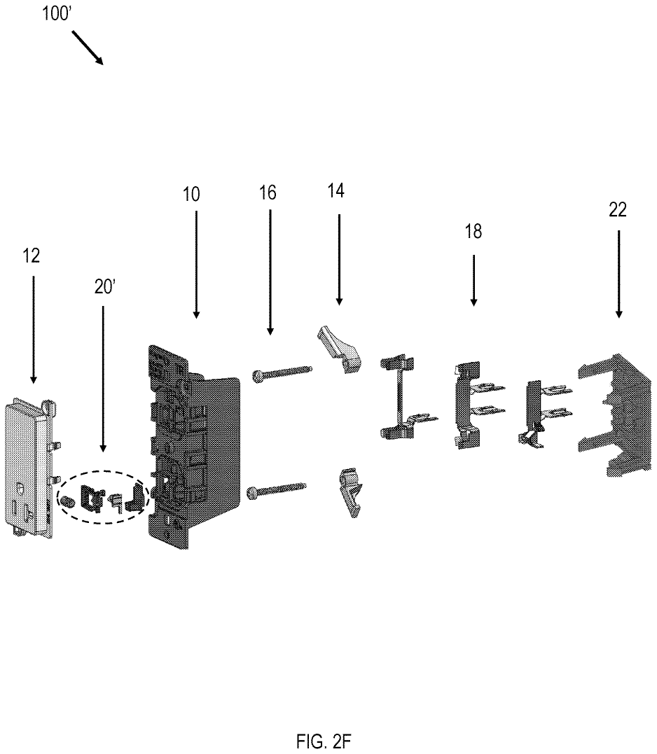

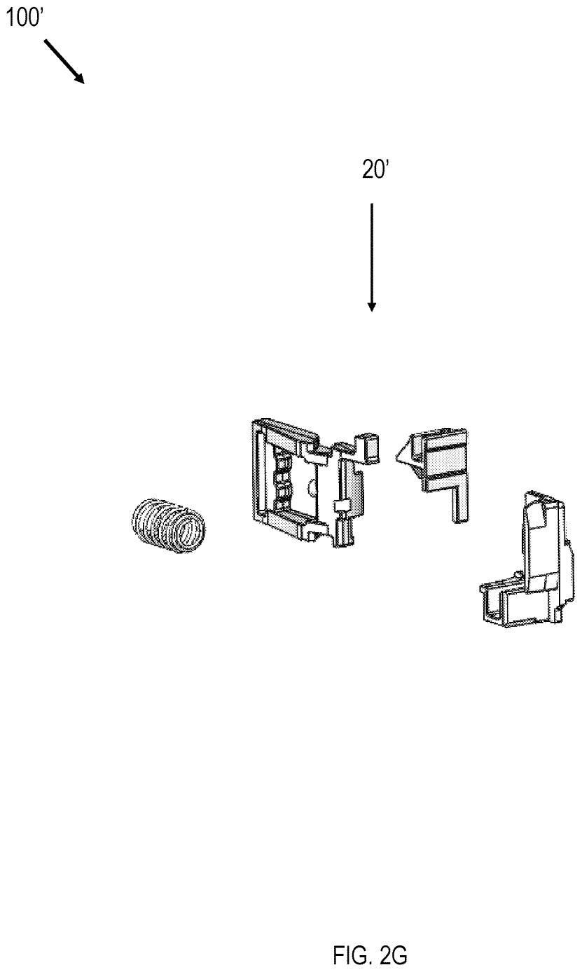

FIGS. 2A-2G show a 20 A version of the tamper-resistant self-contained device 100′ in accordance with an embodiment of the present disclosure.

Referring to FIGS. 2A and 2B, front and front perspective views, respectively of a fully assembled tamper-resistant self-contained device 100′ are shown. The 20 A version 100′ functions and is mechanically similar to the 15 A version 100, except the 20 A version 100′ has a different plug blade receptacle fitting, as shown (and as should be understood by a person of ordinary skill in the art in conjunction with a review of this disclosure and the references incorporated herein).

Referring to FIG. 2C, a rear view schematic representation of the tamper-resistant self-contained device 100′ is shown, according to an embodiment.

Turing to FIG. 2D, a front perspective view of the tamper-resistant self-contained device 100′ with certain components (including the top cover) removed to show certain interior components is shown, according to an embodiment.

Referring to FIG. 2E, a front perspective view of the tamper-resistant self-contained device 100′ with certain components removed to show certain interior components is shown, according to an embodiment.

Referring to FIG. 2F, an exploded view schematic representation of the tamper-resistant self-contained device 100′ is shown, according to an embodiment.

Referring to FIG. 2G, an exploded view of a shutter 20′ is shown.

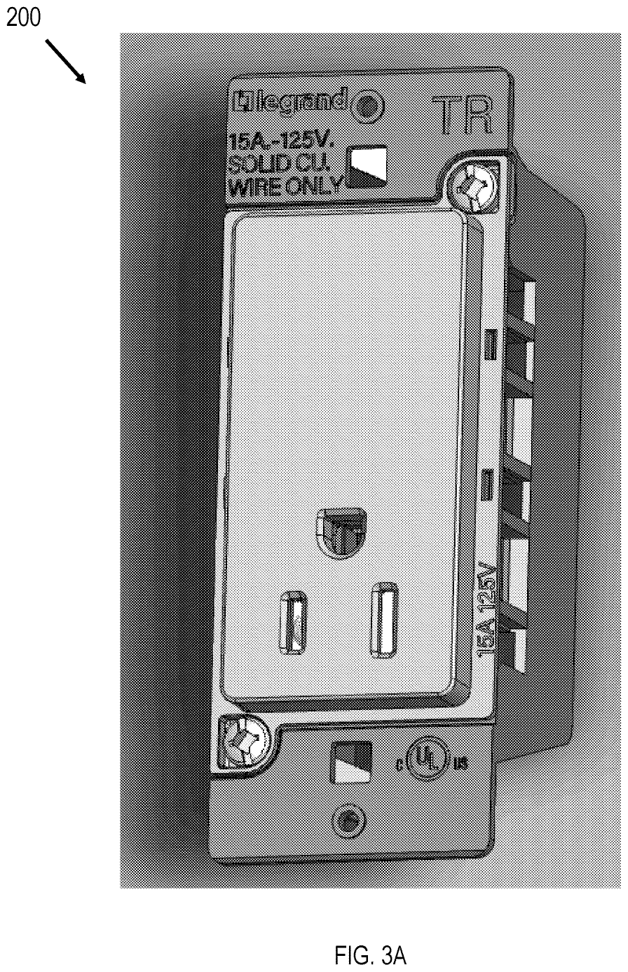

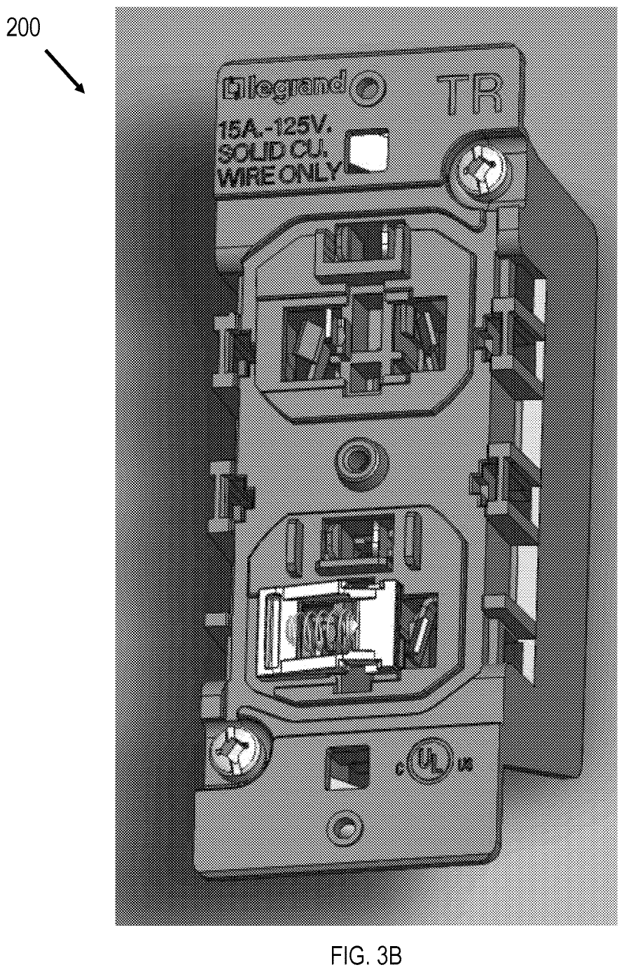

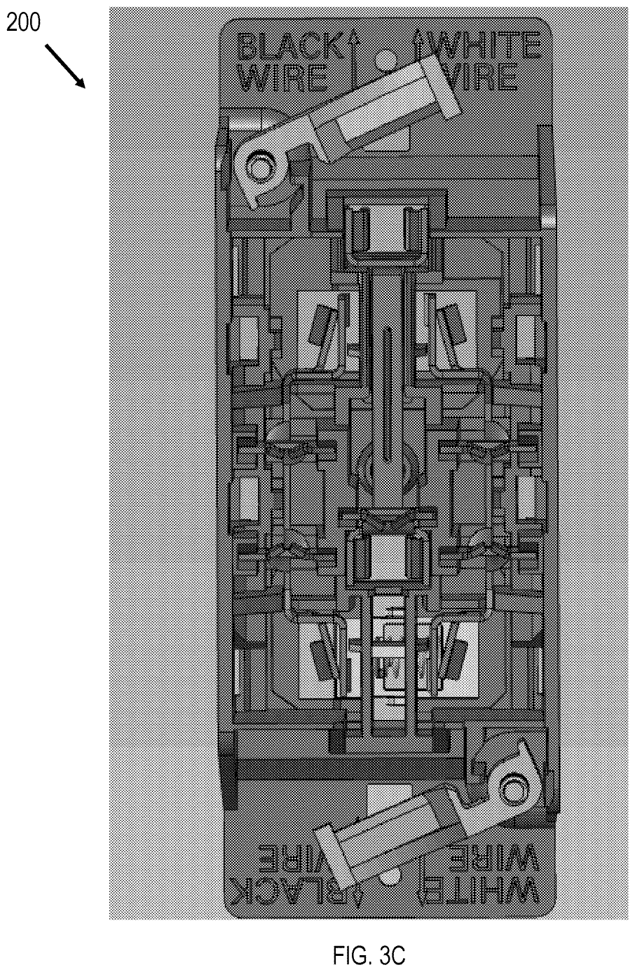

FIGS. 3A-7 show various schematic representations and views of alternative embodiments of this disclosure. These embodiments are intended to be used with both 15 A and 20 A versions and are structurally and functionally similar to embodiments described above, except when stated otherwise.

Referring to FIGS. 3A-3C, a first alternative embodiment 200 is shown. In this embodiment, a single outlet configuration of a 15 A version is shown. In some examples, a 20 A version can be used instead.

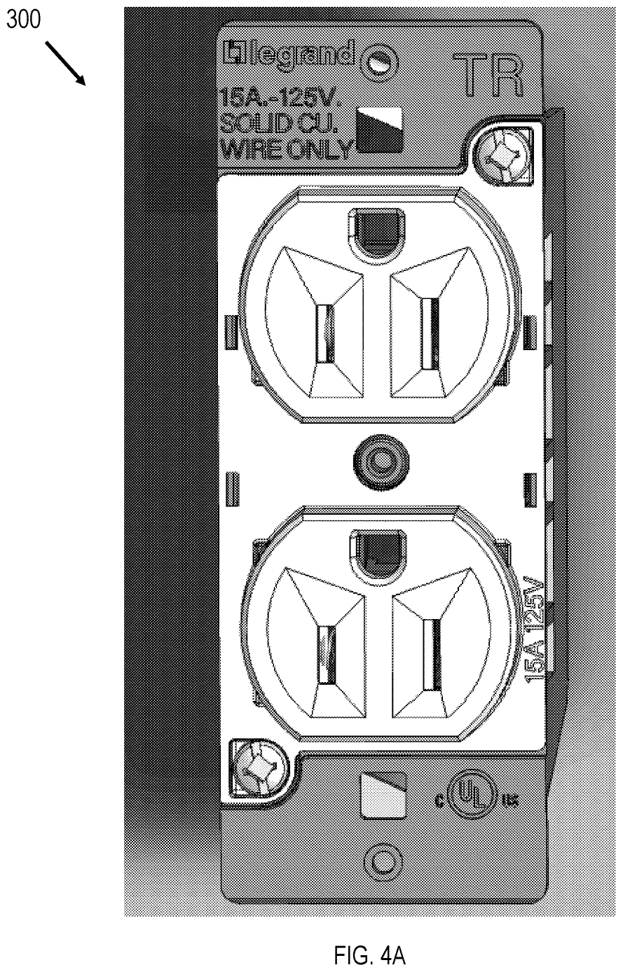

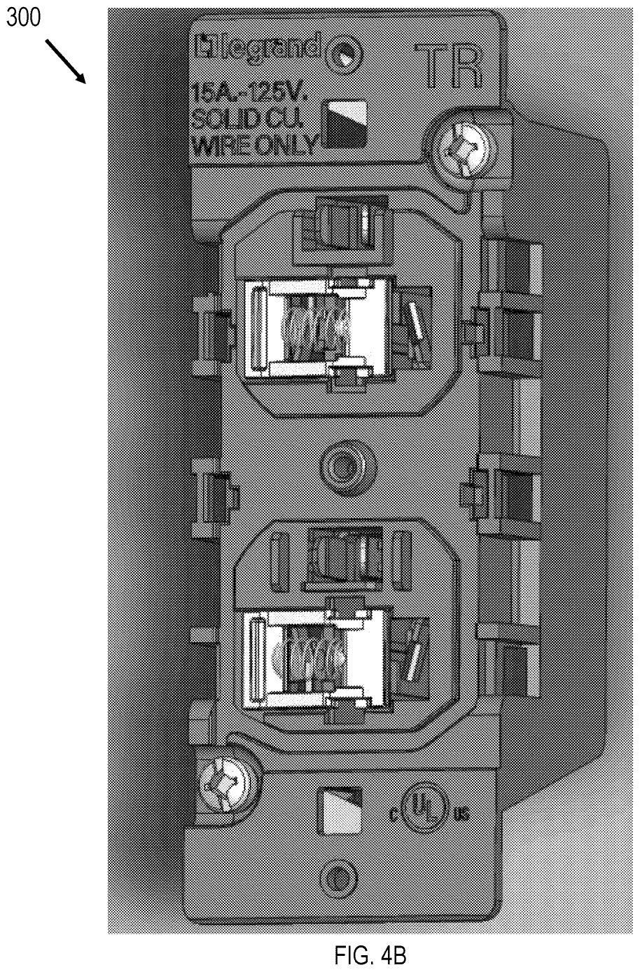

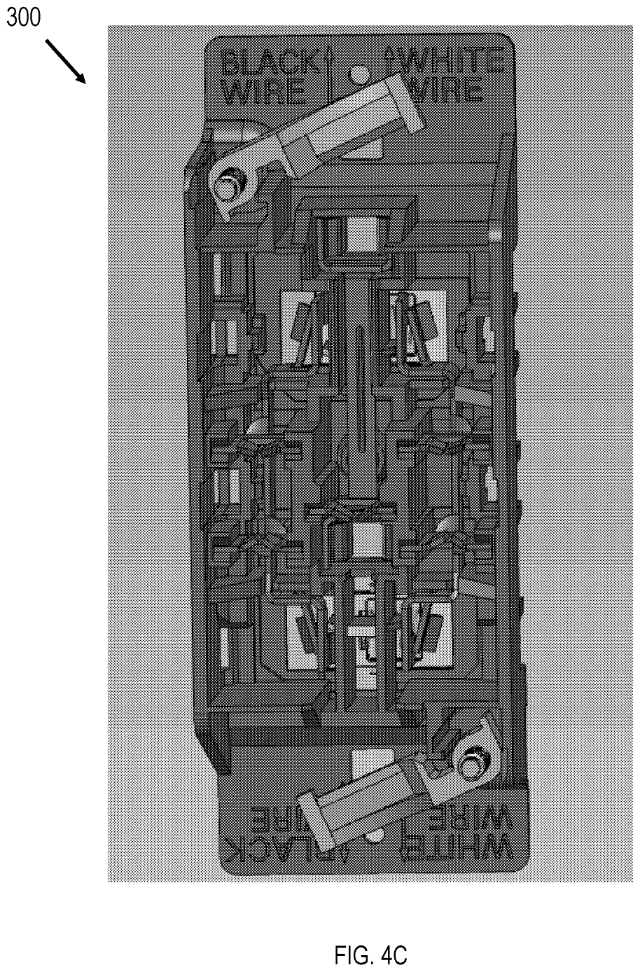

Referring to FIGS. 4A-4C, a second alternative embodiment 300 is shown. In this 15 A duplex version embodiment, the cover plate 12 is aesthetically different (as should be understood by a person of ordinarily skill in the art in conjunction with a review of this disclosure).

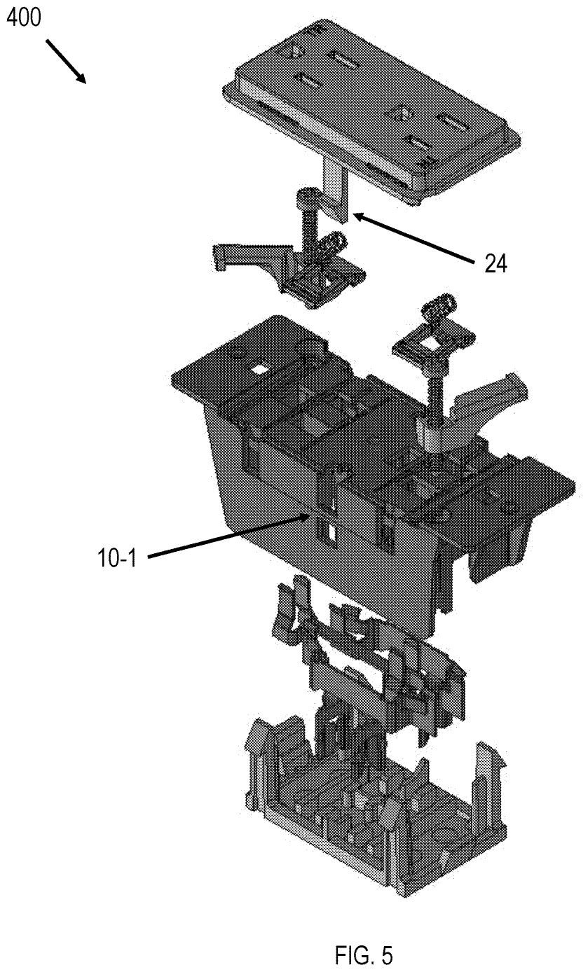

Referring to FIG. 5, an exploded view of a third alternative embodiment 400 is shown. In this embodiment, the cover plate 12 is shown with a clip 24 extending therefrom that can be received by the back body 10 by one or more apertures 10-1 in order to secure the cover plate 12 to it.

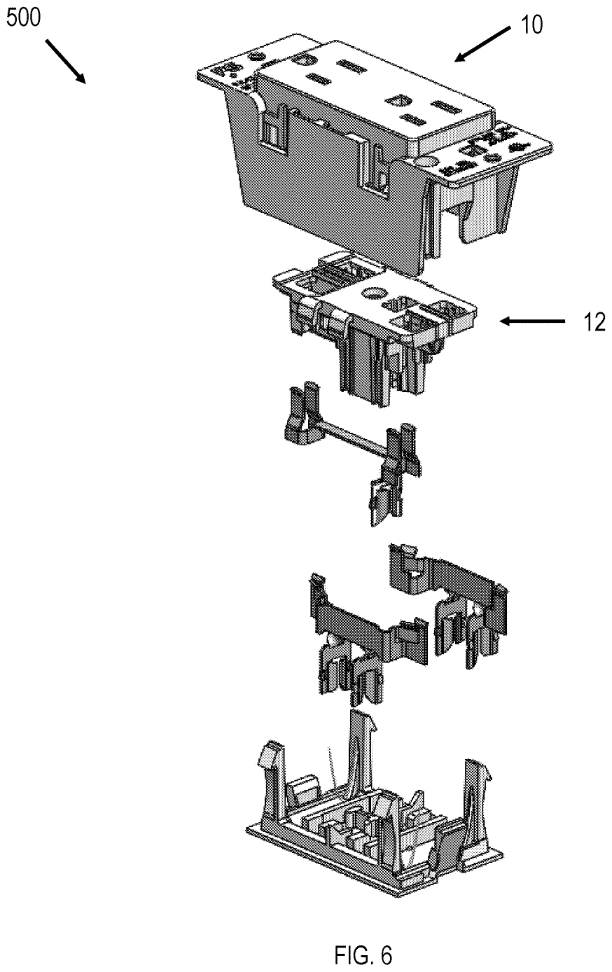

Referring to FIG. 6, an exploded view of a fourth alternative embodiment 500 is shown. In this embodiment, a snap-in tamper-resistant cover plate 12 is shown which is configured to be positioned under an alternative version of the back body 10.

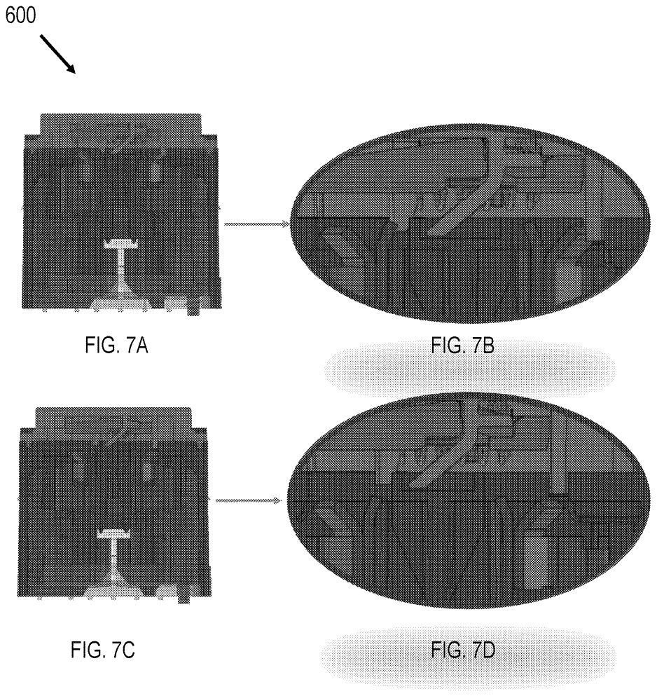

Referring to FIGS. 7A-D, a fifth alternative embodiment 600 of the housing to accommodate a shutter component is shown (bottom—FIGS. 7C-D) and compared to a conventional embodiment (top—FIGS. 7A-B). In this embodiment (bottom), the line and neutral terminals have been lowered in order to clear an interference with the proven tamper-resistant geometry on the front cover (as should be understood by a person of ordinary skill in the art in conjunction with a review of this disclosure and references incorporated herein). In this example, the terminals were lowered by a distance of approximately 0.06″, however other distances may be used depending on the front cover's geometry (as should be understood by a person of ordinary skill in the art in conjunction with a review of this disclosure and references incorporated herein).

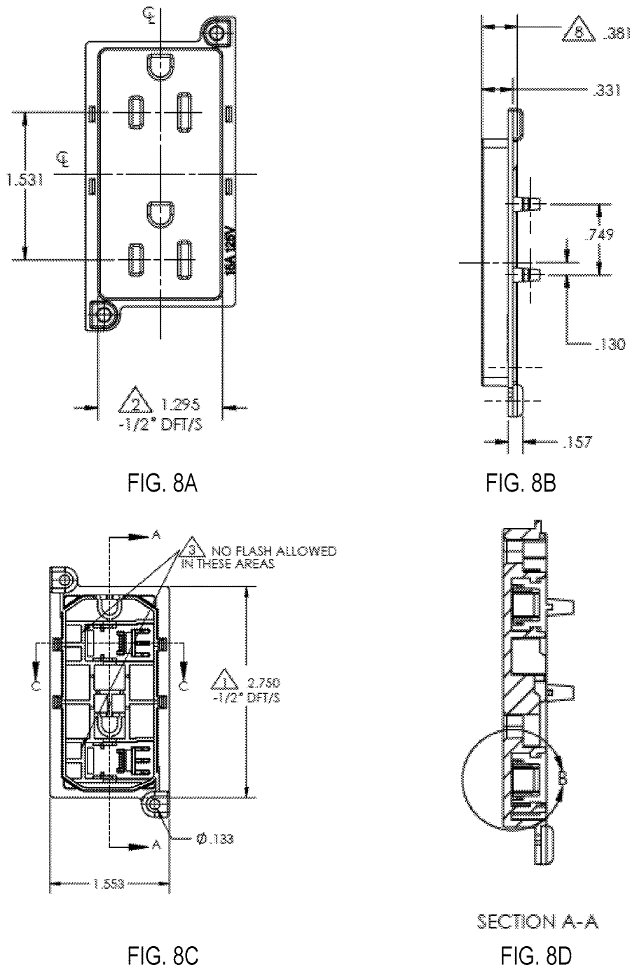

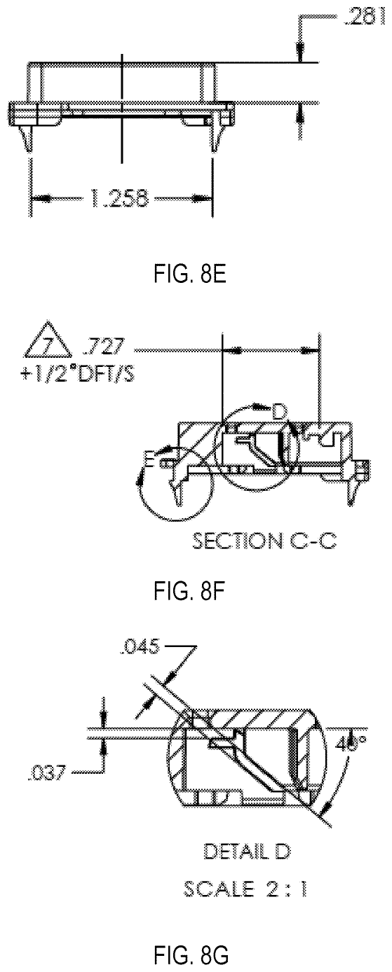

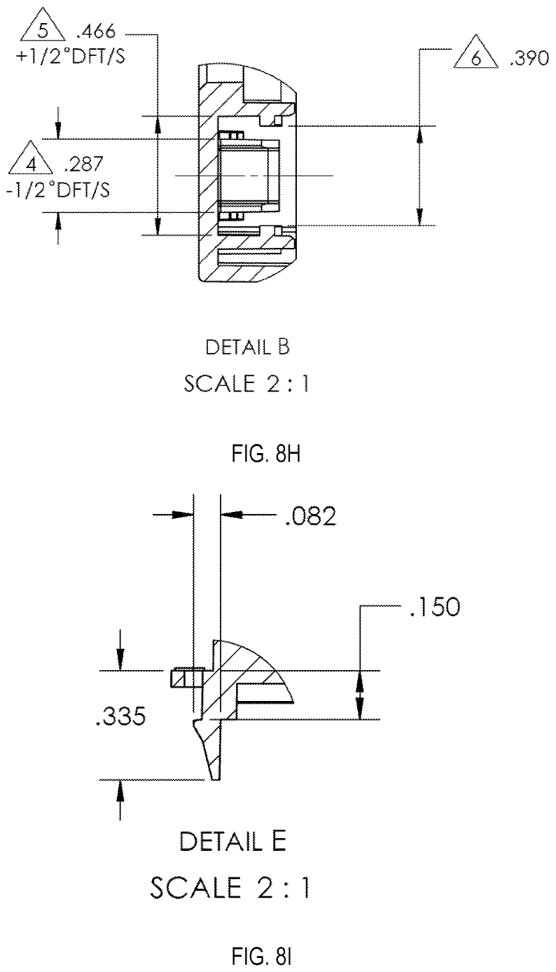

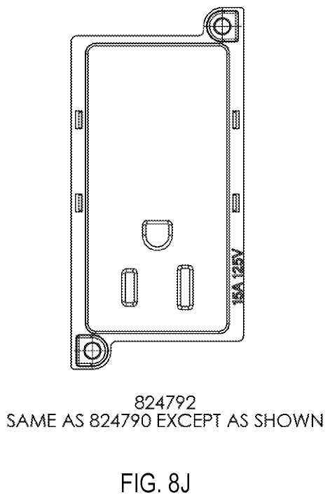

Referring to FIGS. 8-15, multiple view schematic representations of components of embodiments of a tamper-resistant self-contained device are shown. Certain details are provided in some of these figures. The details provided are examples only.

Turning to FIGS. 8A-I, multiple view (including section views) schematic representations of a cover (Deco, 15 A) of a tamper-resistant self-contained device are shown, according to an embodiment. FIG. 8J is top view showing a cover (15 A) of a tamper-resistant self-contained device, with the same details as the device shown in FIGS. 8A-I except for only having openings for a single plug receptacle.

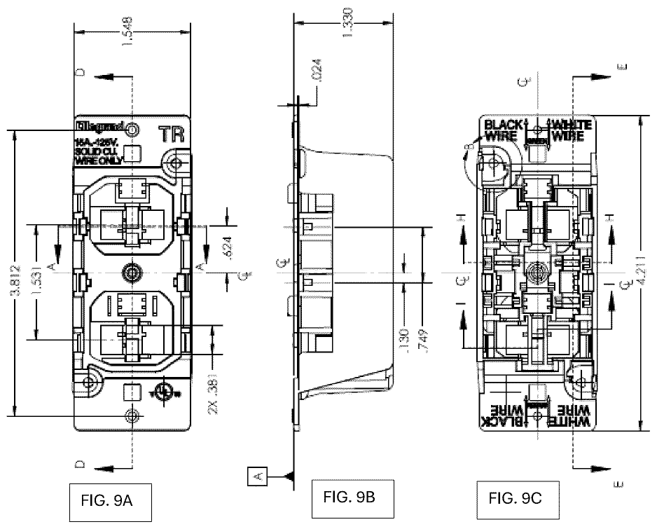

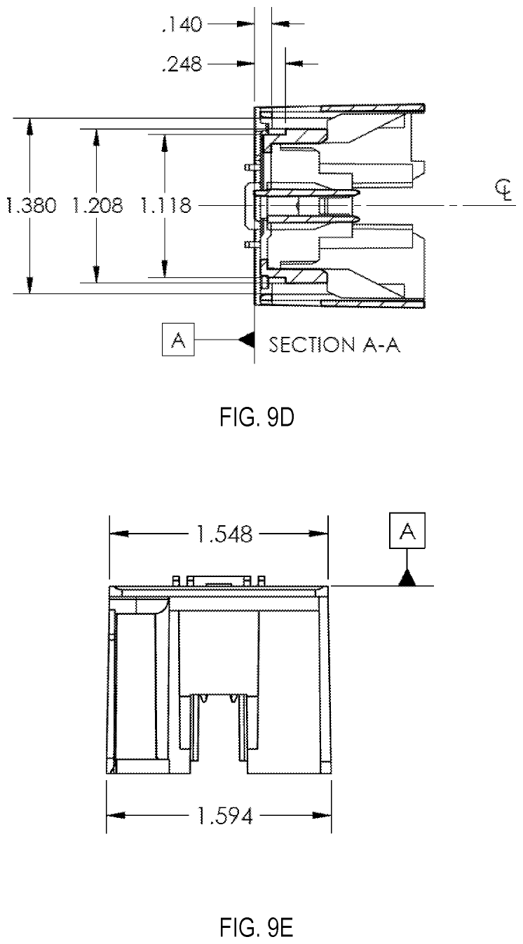

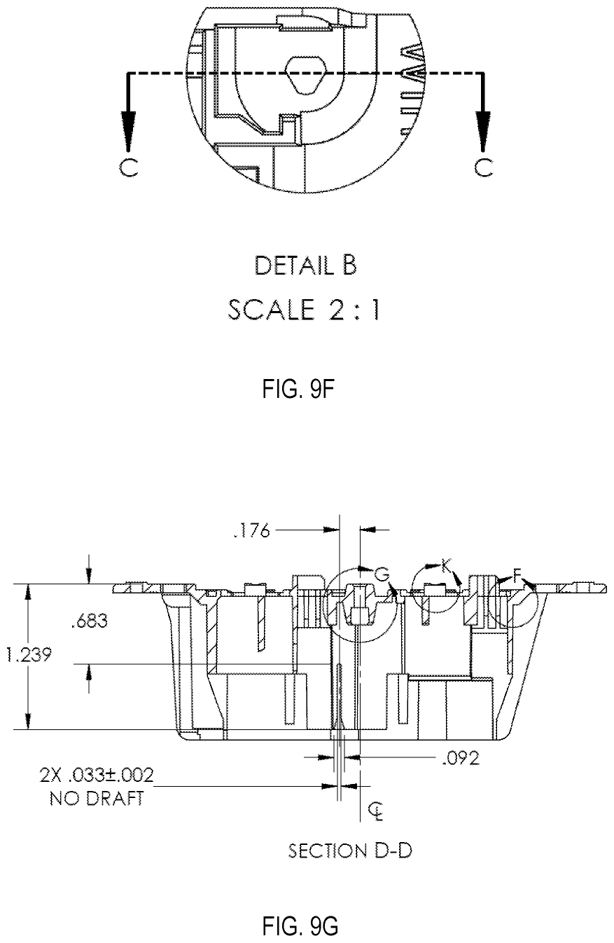

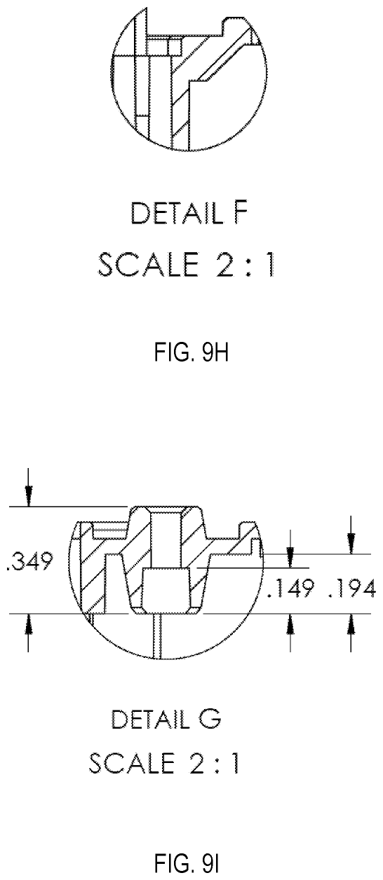

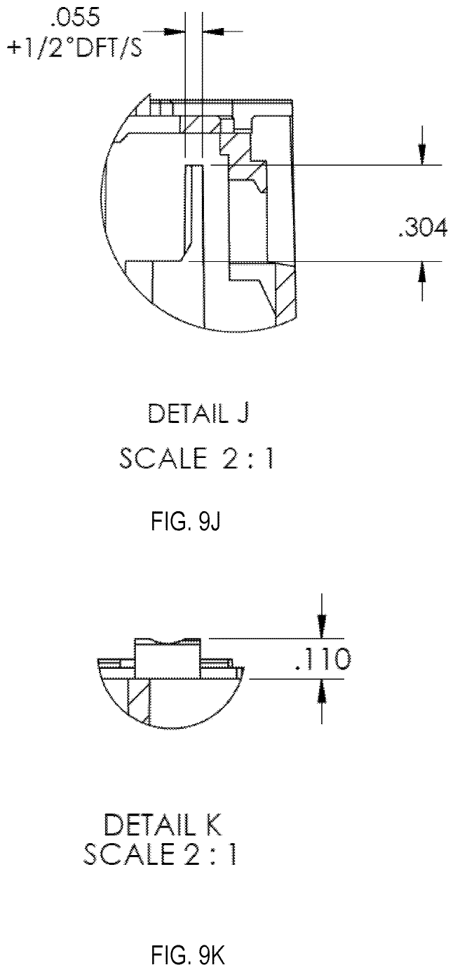

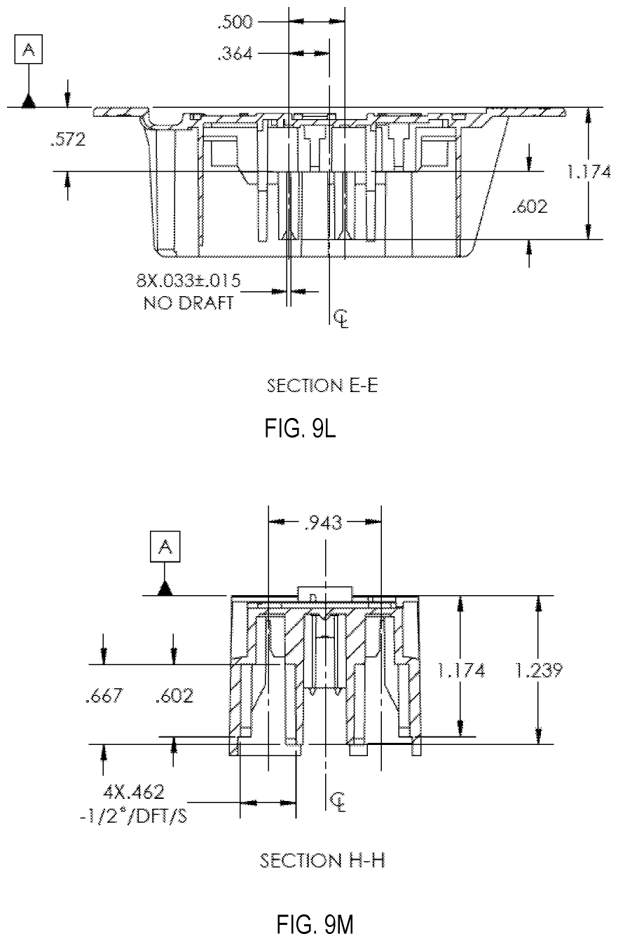

Referring to FIGS. 9A-N, multiple view (including section views) schematic representations of a back body of a tamper-resistant self-contained device are shown, according to an embodiment.

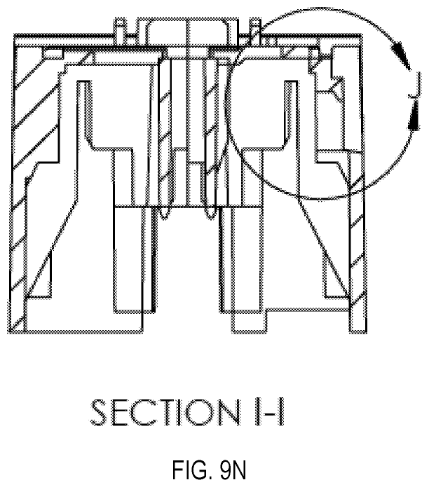

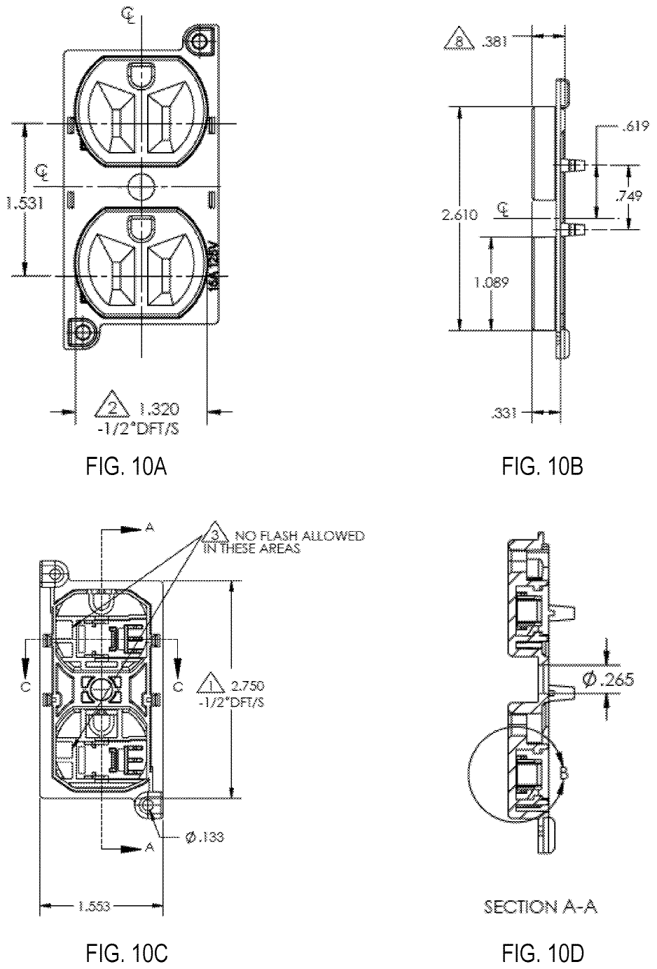

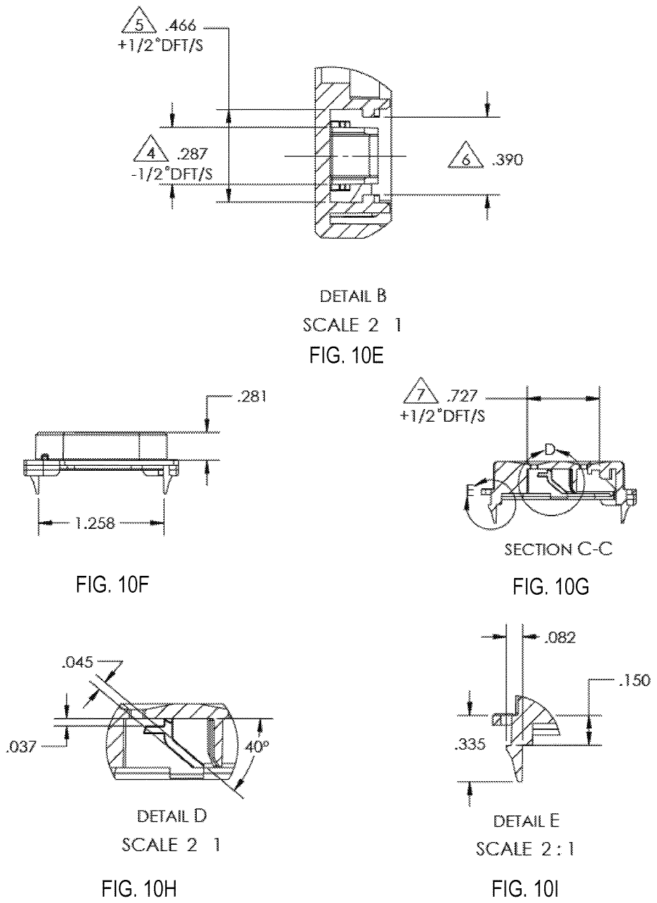

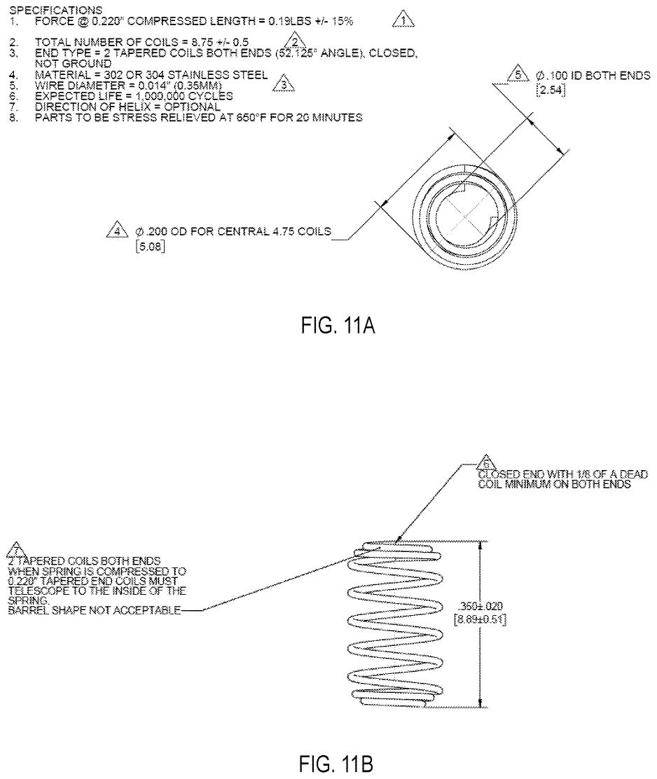

Turning to FIGS. 10A-I, multiple view (including section views) schematic representations of a cover (Duplex, 15 A) of a tamper-resistant self-contained device are shown, according to an embodiment.

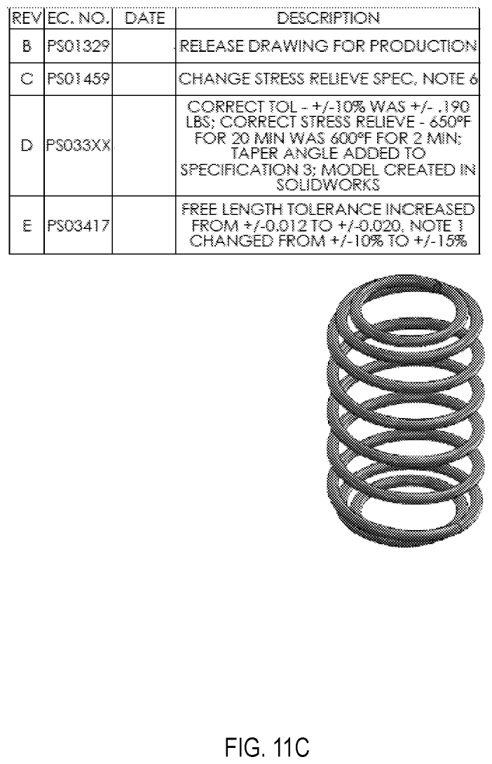

Referring to FIGS. 11A-C, multiple view (including section views) schematic representations of a spring of a taper resistant mechanism of a tamper-resistant self-contained device are shown, according to an embodiment.

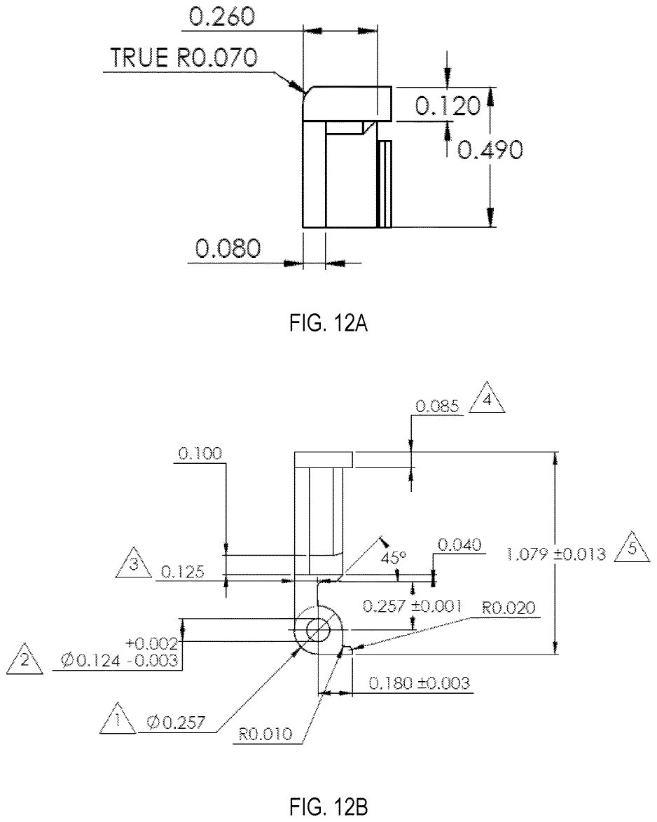

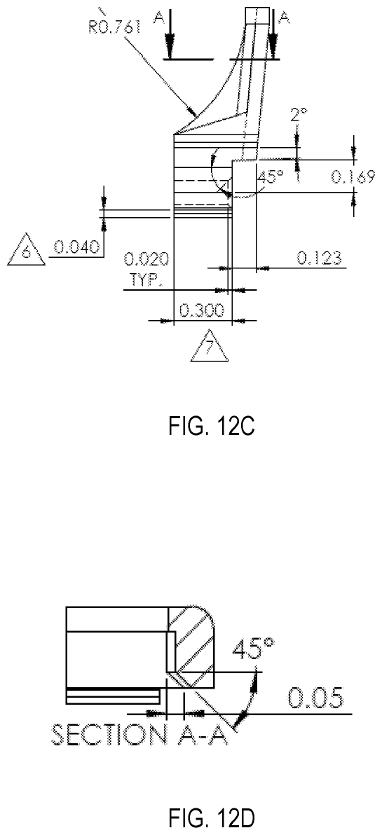

Referring to FIGS. 12A-D, multiple view (including section views) schematic representations of a spring of a swing bracket of a tamper-resistant self-contained devices are shown, according to an embodiment.

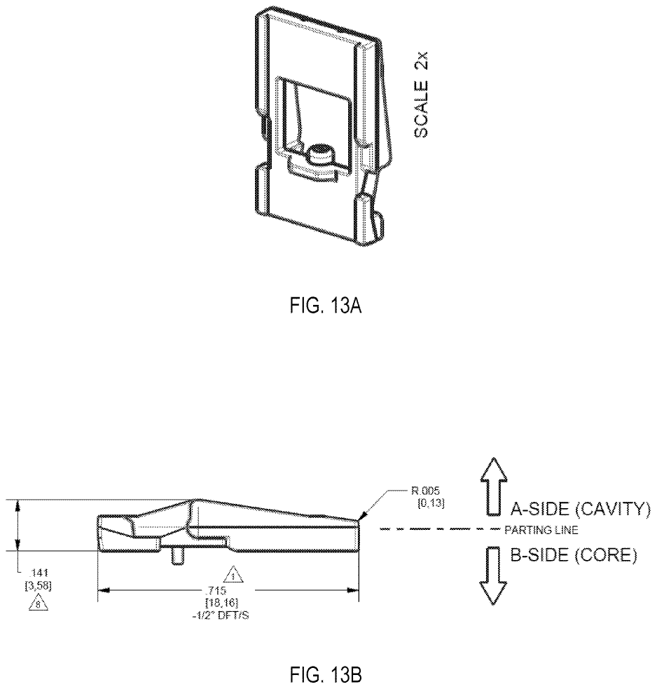

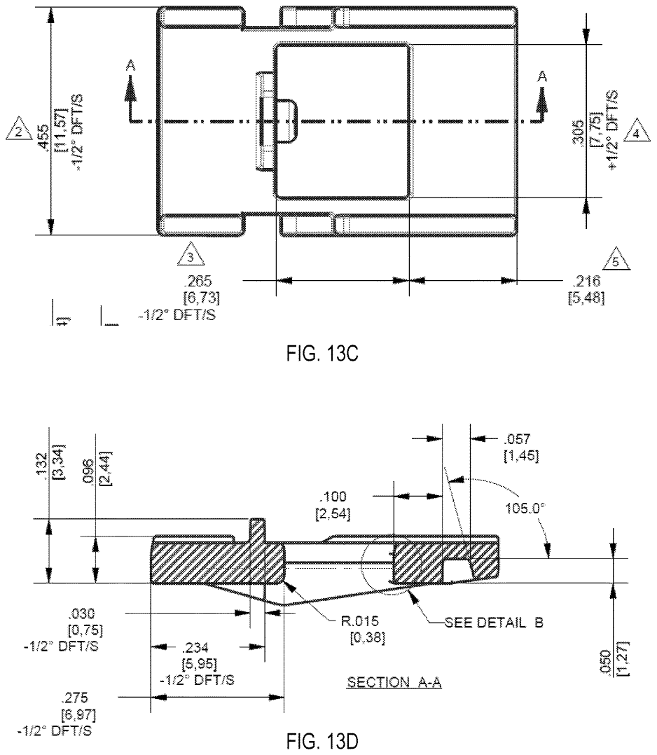

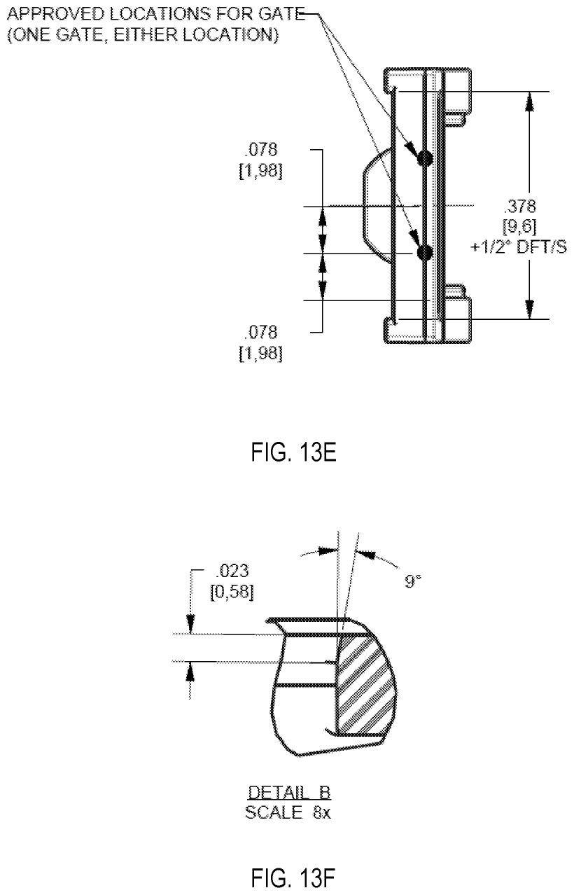

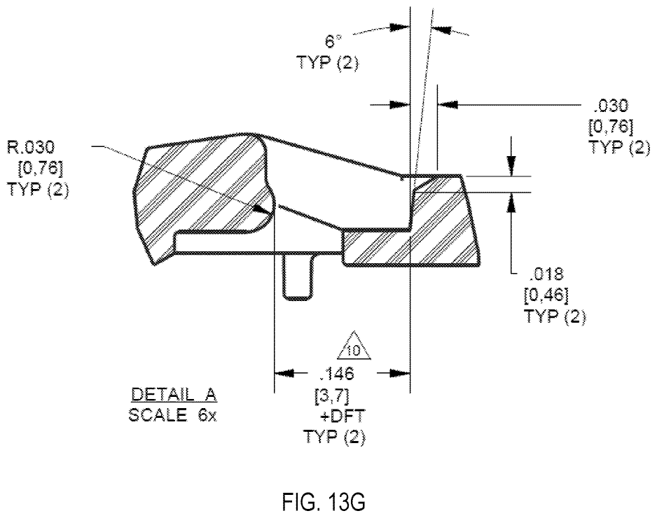

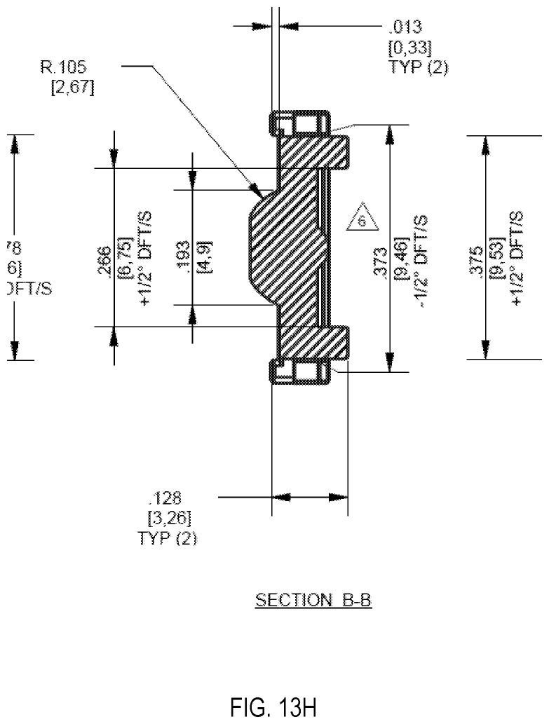

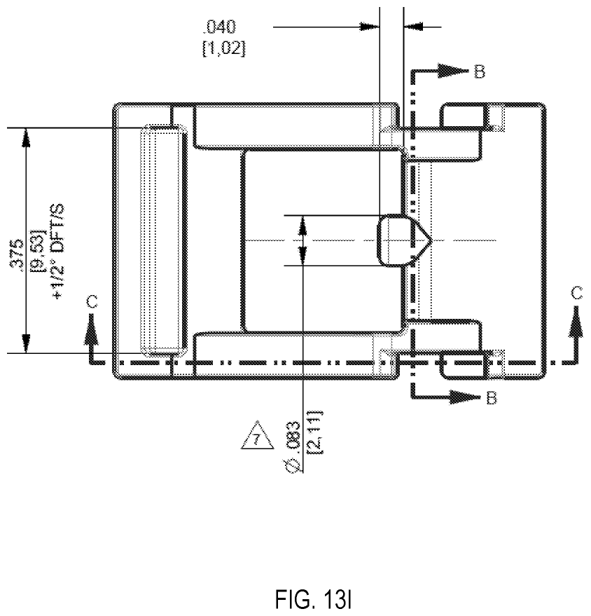

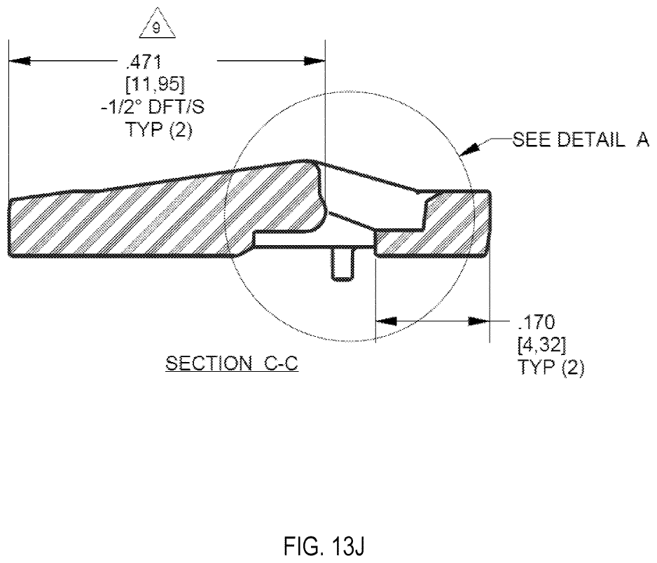

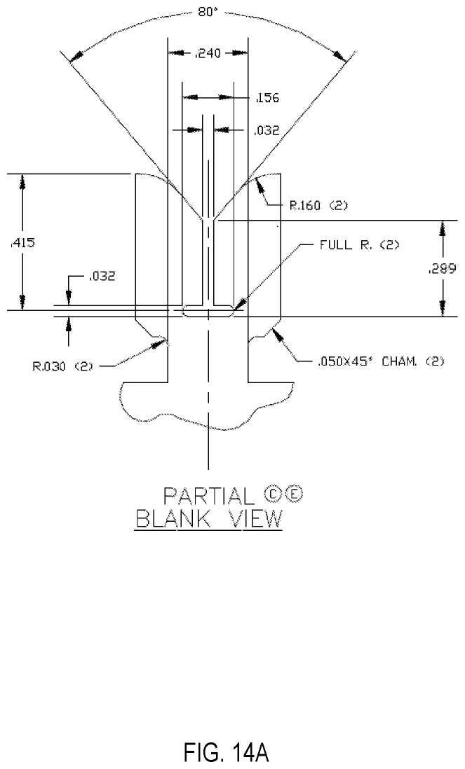

Referring to FIGS. 13A-J, multiple view (including section views) schematic representations of a shutter of a tamper-resistant self-contained device are shown, according to an embodiment.

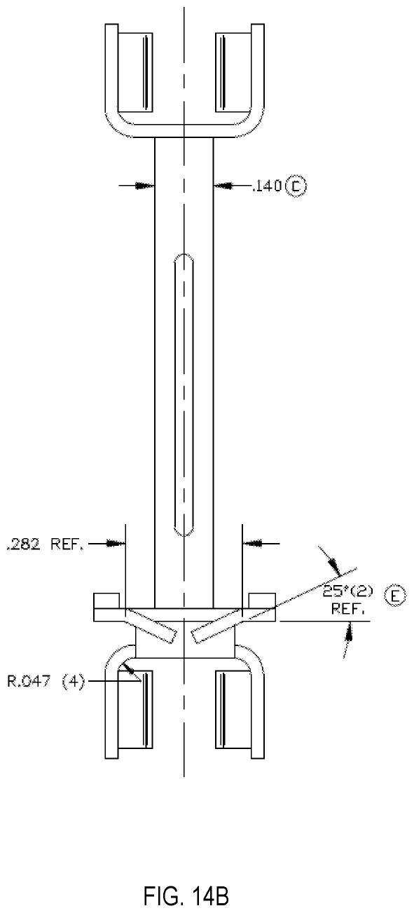

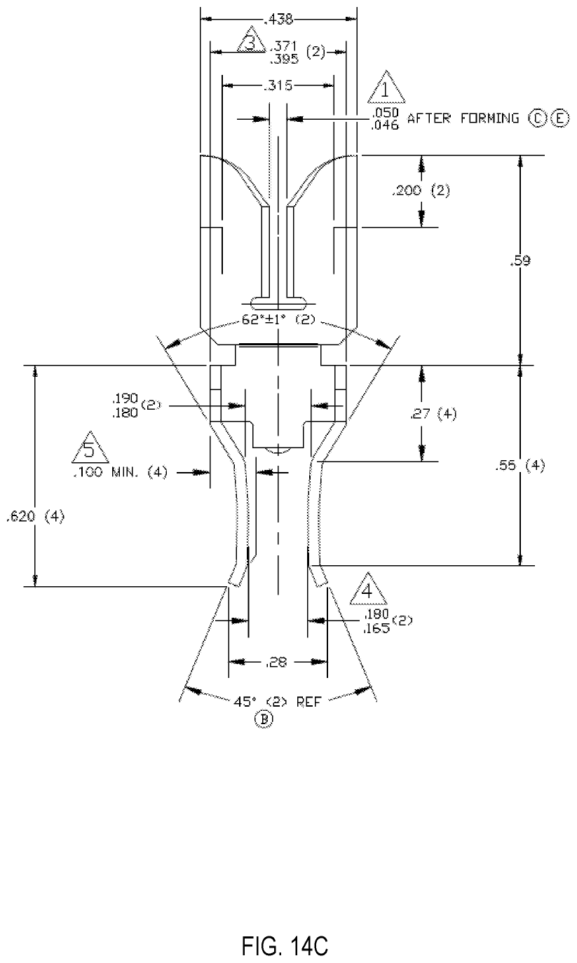

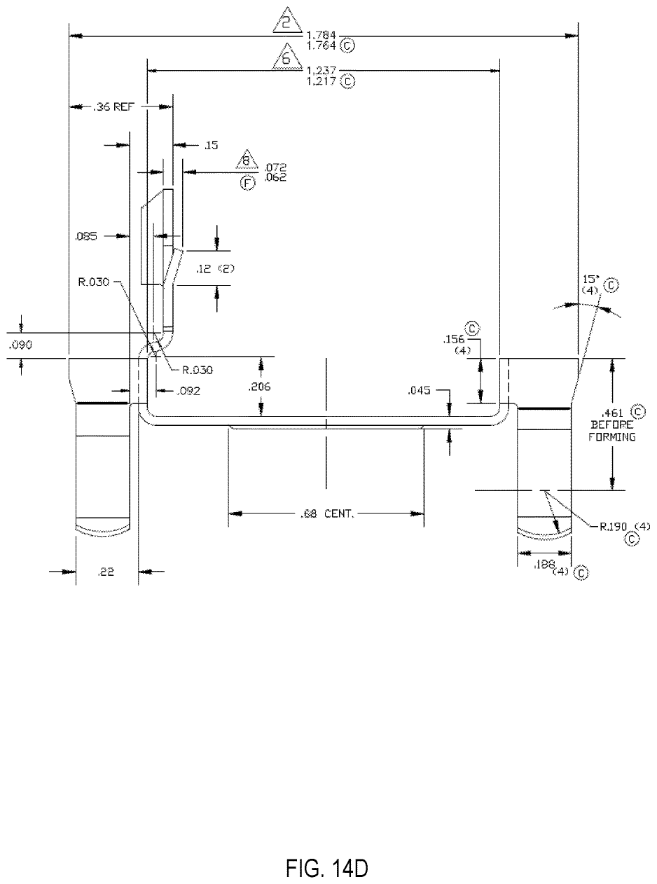

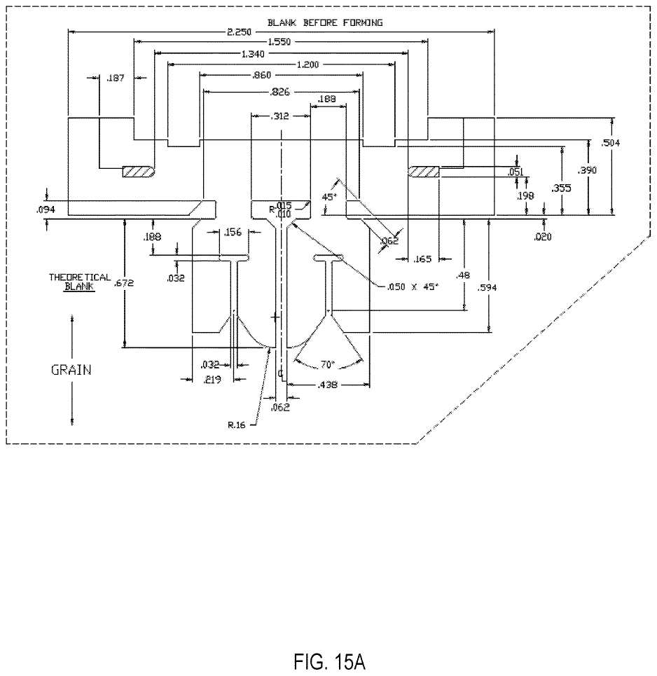

Turning to FIGS. 14A-D, multiple view (including section views) schematic representations of a ground contact of a tamper-resistant self-contained device are shown, according to an embodiment.

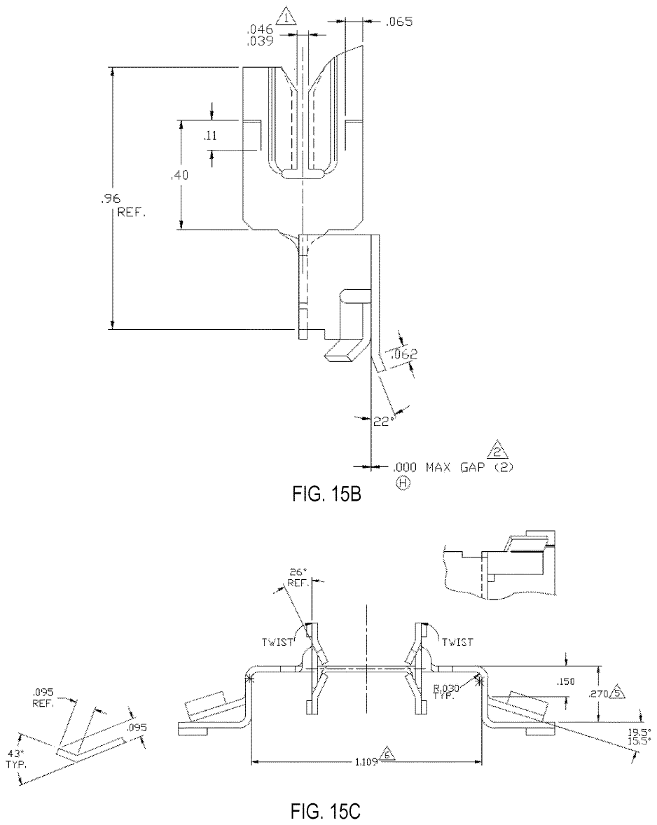

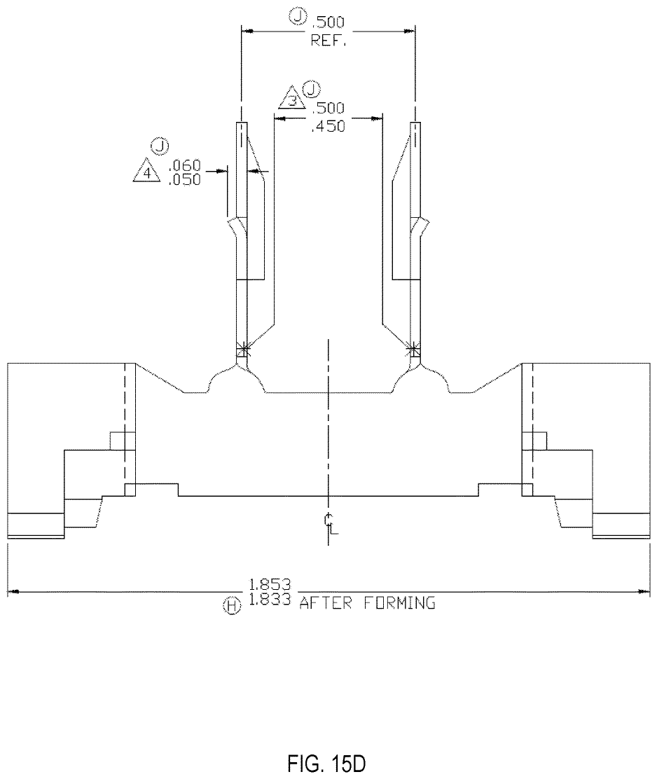

Referring to FIGS. 15A-D, multiple view (including section views) schematic representations of a line terminal of a tamper-resistant self-contained device are shown, according to an embodiment.

While various embodiments are described above, embodiments and aspects thereof can be combined in any way mechanically possible.

What is claimed is:

1. A tamper-resistant self-contained wiring device, comprising:
a back body having a first surface;
a cover removably coupled to said first surface of said back body and having a plurality of apertures formed therethrough dimensioned to accept a plurality of plug blades; and
a first tamper-resistant mechanism housed within said back body, wherein the first tamper-resistant mechanism is configured to move from a first position to a second position.

2. The tamper resistant self-contained wiring device of claim 1, wherein the first tamper-resistant mechanism further comprises a shutter component.

3. The tamper resistant self-contained wiring device of claim 2, wherein the first tamper-resistant mechanism further comprises a spring component configured to move the tamper resistant mechanism from the first position to the second position.
